(19) United States
(12) Patent Application Publication
(10) Pub. No.: US 2009/0244048 A1
(43) Pub. Date: Oct. 1, 2009

(54) Image display apparatus, image pickup apparatus, computer readable recording medium for recording processing program to control image display apparatus, and method of controlling image display apparatus

(75) Inventor: Kazuya Yamanaka, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Olympus Corporation, Shibuya-ku (JP)

(21) Appl. No.: 12/150,332

(22) Filed: Apr. 24, 2008

(30) Foreign Application Priority Data
Apr. 24, 2007 (JP) 2007-114515

(51) Int. Cl. G06F 3/038; H04N 5/63

(52) U.S. Cl. 345/212; 348/372; 348/E05.127

(57) ABSTRACT

Image display apparatus includes an EVF-display section which allows the pixel shift element to cyclically vary a spatial position of images displayed on the display element for a high definition display with more pixels compared with the display element by allowing extended image observation via an eye-optical system, an EVF-display control section which controls the EVF-display section in such modes as a four-point pixel shift, a two-point pixel shift, a partial pixel shift, a lowpass filter (LPF), and the pixel shift OFF, each with different power consumption, a power source, a power source state determination section for determining whether the power source is driven by the battery or the external power source, and the remaining battery level, and a pixel shift display determination section for setting the display mode with the lower power consumption in the order of the low-remaining battery level, the high-remaining battery level, and the externally-driven power source.

This application claims benefit of Japanese Application No. 2007-114515 filed in Japan on Apr. 24, 2007, the contents of which are incorporated by this reference.

### BACKGROUND OF THE INVENTION

1. Field of the Invention

The present invention relates to an image display apparatus capable of performing the high-definition display with the number of pixels more than that of the display element by performing the pixel shift, an image pickup apparatus, a computer readable recording medium for recording the processing program to control the image display apparatus, and a method of controlling the image display apparatus.

2. Description of the Related Art

Recently, the image receptor for high-vision (HD) broadcasting, that is, so-called high-vision television has become widely used. Accompanied with the improvement in the performance of the personal computer (PC), the number of pixels of the display apparatus connected to the PC has been increased as well. In this way, the resolution of various types of the display apparatuses has become higher in the living environment.

Accompanied with the high resolution trend of the various display apparatuses, the number of pixels of the display of the battery activated handheld terminal (for example, PDA (Personal Digital Assistant) and cell phone) has been increasing.

As the size of the aforementioned handheld terminal is intended to be reduced for portability, that is, to have the compact package, it is difficult to allow the display area to occupy the large space. As one of solutions for solving the aforementioned problem, the Electronic View Finder (hereinafter referred to as EVF as the finder for observing the image displayed on the compact display element through magnification with the eye lens) is used as the means for displaying the image on the handheld terminal. Upon the use of the EVF, the user is expected to peep at the image through the eye lens. The virtual image may be extended to be observed so as to allow the image to be spuriously shown on the large display. By combining the EVF with the handheld terminal makes it possible to observe the image on the large screen with sufficient pixel number irrespective of the use of the compact handheld terminal.

The EVF generally uses the compact display element. Increase in the number of pixels of the display element may markedly reduce the area corresponding to the single pixel. When the area corresponding to the single pixel is reduced, the yield may be decreased or the process may reach the limit in the course of manufacturing.

In the field of the display apparatus for observing the image on the screen wider than the actual display element, for example, the projector and HMD (Head Mounted Display), the efforts for increasing the number of pixels and enhancing the resolution to be higher have been made by the use of pixel shift technology. As the position of the pixel viewed from the observer, that is, the apparent pixel position is time-series shifted, a plurality of pixel positions per the single pixel may be displayed.

U.S. Pat. No. 3,547,015 discloses the pixel shift technology, that is, the image pickup apparatus intended to increase pixels upon the image pickup through the pixel shift technique, and the display apparatus intended to increase pixels upon the image display through the pixel shift technique which are independently described (the technology of high-definition image display using the pixel shift applied to the image pickup apparatus is not disclosed). The disclosed pixel shift technology is designed to increase the pixels and to improve the resolution simultaneously using the pixel shift element which functions in spatially shifting the optical pixel position, and the image display element which displays the image corresponding to the pixel shifted position in synchronization with the shift timing.

Japanese Unexamined Patent Application Publication No. 2001-157229 discloses in detail that the TN liquid crystal is combined with the birefringent plate to form the pixel shift element, and further discloses the technology conforming to various input formats by switching the drive mode.

If the aforementioned pixel shift technology is applied to the EVF, the image display with increased pixel numbers may be realized while keeping the display element compact without encountering the manufacturing problems as described above.

As the number of pixels of the image to be displayed is increased, the image processing circuit which is large enough to perform the high speed processing such as DSP (Digital Signal Processor) is required, thus increasing the power consumption. This may reduce the time for using the battery activated handheld terminal, and accordingly, another important task to save power has to be overcome.

The number of pixels of the image pickup device (CCD or CMOS) for the image pickup apparatus such as the digital camera and the video camera has been increasing. Under the influence of the trend using the increased number of pixels, the image pickup apparatus is likely to increase the power consumption for the entire system. However, as most of the digital cameras and the video cameras on the market are designed to be driven by the battery, it is also important for the image pickup apparatus to reduce the power consumption.

Japanese Unexamined Patent Application Publication No. 5-207339 discloses the technology for saving power consumption. In the disclosure, the sensor is used to determine whether or not the user is handling the battery driven video camera. If it is determined that the video camera is not used, the power is not fed to the view finder such that the power is fed only when the video camera is used to save the power consumption. The photo sensor as the aforementioned sensor is disposed in the grip portion so as to determine whether the user grips the grip portion. The photo sensor may also be disposed in the view finder portion so as to determine whether the user peeps in the view finder portion.

Japanese Unexamined Patent Application Publications Nos. 2-112120 and 9-18769 disclose the determination whether or not the user is handling the image pickup apparatus such as the camera. The former document discloses the technology for detecting whether the user presses the release button halfway, and the latter document discloses the technology for detecting the rotation of the focus ring.

In Japanese Unexamined Patent Application Publication No. 2001-285700 intended to reduce the power consumption in the system of the image pickup apparatus, the high quality mode/standard mode/economy mode may be set such that the gray level (quantized bit number) for A/D conversion in the signal processing circuit is set to 12/10/8 bit, respectively in accordance with the corresponding mode to select the consumption current value.

The use of the polarized switching liquid crystal for the pixel shifting may fail to obtain the desired performance upon the change in the temperature as the liquid crystal exhibits the thermal property. Japanese Unexamined Patent Application Publication No. 11-326877 discloses that the temperature sensor is disposed in the vicinity of the polarized switching liquid crystal to adjust the timing for driving the polarized switching liquid crystal based on the detected temperature.

Japanese Unexamined Patent Application Publication Nos. 9-133904 and 2002-328402 disclose the use of the liquid crystal to change the refracting angle of the incident polarized light and the displacement direction based on the birefringence caused by the inclined liquid crystal molecules.

The technology for the pixel shifting using the mechanical oscillation has been generally proposed.

Generally, the EVF installed in the commercial image pickup apparatus is structured to display the picked up image with the number of pixels smaller than that of the image pickup device.

The EVF which employs the pixel shift technology may be installed in the image pickup apparatus to display the image with the number of pixels closer to that of the image pickup device using the display element (LCD) with the smaller number of the pixels.

The pixel shift requires power for driving the pixel shift element. As the pixel shift is used to display the images of a plurality of sub-frames while being spatially shifted with the single display element to display the single frame image as a whole, the single frame image has the number of pixels larger than that of the display element by plural times. The frame image with multi-pixel requires the power for the image processing in accordance with the pixel size. The power required for processing the frame image with multi-pixel is larger than the power required for driving the pixel shift element.

In the case where the image with large pixel size is displayed using the pixel shift technology, the increase in the power consumption as a whole is inevitable. However, the power saving is required for the battery driven apparatus, thus demanding some sort of solution.

Japanese Unexamined Patent Application Publications No. 5-207339 does not disclose the EVF with the pixel shift technology, and accordingly discloses no description for power saving using the pixel shift feature.

U.S. Pat. No. 3,547,015 and Japanese Unexamined Patent Application Publication No. 2001-157229 disclose the pixel shift technology, but nothing about the power saving by taking advantage thereof.

Japanese Unexamined Patent Application Publication No. 2001-285700 discloses the technology which allows the power consumption to be selectable by changing the data size (bit number) of the image in accordance with the mode, but nothing about the power saving by taking advantage of the pixel shift technology.

The battery driven image display apparatus provided with the section for displaying the extended image through the pixel shift such as the EVF using the pixel shift technology, thus demands the technology for saving power by taking advantage of the pixel shift feature.

### SUMMARY OF THE INVENTION

Accordingly, it is an object of the present invention to provide an image display apparatus capable of reducing the power consumption of the apparatus provided with the pixel shift extension display section which enables the pixel shift in accordance with the remaining battery level, the image pickup apparatus, the computer readable recording medium for recording the processing program to control the image display apparatus, and a method of controlling the image display apparatus.

The present invention provides an image display apparatus which includes a pixel shift extension display section having a display element, a pixel shift element which enables a high definition display with a number of pixels more than a number of pixels of the display element by cyclically varying a spatial position of an image to be displayed on the display element, and an extension optical system which extends the image displayed on the display element through the pixel shift element, display control means which controls the pixel shift extension display section in one of a plurality of display modes each having a different pixel shift operation and a different power consumption, a power source structured to receive power at least from a battery, a power source state determination section which determines a remaining level of the battery, and mode set means which sets the display mode controlled by the display control means in such a way that the display mode in a case in which a determination result of the power source state determination section shows that the remaining level of the battery is relatively low is a display mode with power consumption lower than that of the display mode in a case in which the determination result shows that the remaining level of the battery is relatively high.

The present invention further includes the image display apparatus and image pickup means for picking up the image. The image display apparatus is structured to be an image pickup apparatus capable of displaying the image picked up by the image pickup means.

The present invention provides a computer readable recording medium for storing a processing program of controlling an image display apparatus which includes a pixel shift extension display section having a display element, a pixel shift element which enables a high definition display with a number of pixels more than a number of pixels of the display element by cyclically varying a spatial position of an image to be displayed on the display element, and an extension optical system which extends an image displayed on the display element through the pixel shift element, display control means which controls the pixel shift extension display section in one of a plurality of display modes each having a different pixel shift operation and a different power consumption, a power source structured to receive power at least from a battery, and a power source state determination section which determines with respect to a remaining level of the battery. The processing program includes the steps of allowing the power source state determination section to determine the remaining level of the battery, setting a display mode in such a way that the display mode in a case in which the determined remaining level of the battery is relatively low is a display mode with power consumption lower than that of the display mode in the case in which the remaining level of the battery is relatively high, and allowing the display control means to control the pixel shift extension display section in the set display mode.

The present invention provides a method of controlling an image display apparatus which includes a pixel shift extension display section having a display element, a pixel shift element which enables a high definition display with a number of pixels more than a number of pixels of the display element by cyclically varying a spatial position of an image to be displayed on the display element, and an extension optical system which extends an image displayed on the display element through the pixel shift element, display control means which controls the pixel shift extension display section in one of a plurality of display modes each having a different pixel shift operation and a different power consumption, a power source structured to receive power at least from a battery, and a power source state determination section which determines with respect to a remaining level of the battery. The method includes the steps of allowing the power source state determination section to determine the remaining level of the battery, setting a display mode in such a way that the display mode in a case in which the determined remaining level of the battery is relatively low is a display mode with power consumption lower than that of the display mode in the case in which the remaining level of the battery is relatively high, and allowing the display control means to control the pixel shift extension display section in the set display mode.

The above and other objects, features and advantages of the invention will become more clearly understood from the following description referring to the accompanying drawings.

### BRIEF DESCRIPTION OF THE DRAWINGS

FIG. 1 is a block diagram showing a structure of an image pickup apparatus provided with an EVF display section which employs the pixel shift technology according to an embodiment of the present invention;

FIGS. 2A to 2D show a four-point pixel shift operation performed by a pixel shift element according to the embodiment;

FIGS. 3A to 3F are timing charts with respect to each operation for driving a light source, a display element, and a polarized switching liquid crystal in the four-point pixel shift mode according to the embodiment;

FIGS. 4A to 4E are timing charts with respect to each operation for driving a color display element and the polarized switching liquid crystal in the four-point pixel shift mode according to the embodiment;

FIGS. 5A to 5F are timing charts with respect to each operation for driving a light source, the display element, and the polarized switching liquid crystal in a two-point pixel shift mode according to the embodiment;

FIGS. 6A to 6F are timing charts with respect to each operation for driving the light source, the display element and the polarized switching liquid crystal in an LPF mode according to the embodiment;

FIG. 7 is a plan view of a structure for detecting whether or not the image pickup apparatus is in use;

FIG. 8 is a flowchart showing bifurcation of each operation of the image pickup apparatus in accordance with the power source state and temperature;

FIG. 9 is a flowchart showing the detail of the operation by the external power supply in step S3 of the flowchart shown in FIG. 8 according to the embodiment;

FIG. 10 is a flowchart showing the detail of the normal battery operation in step S5 of the flowchart shown in FIG. 8 according to the embodiment;

FIG. 11 is a flowchart showing the detail of the operation in a first eco mode performed in step S7 of the flowchart shown in FIG. 8 according to the embodiment;

FIG. 12 is a flowchart showing the detail of the operation in a second eco mode performed in step S9 of the flowchart shown in FIG. 8 according to the embodiment;

FIG. 13 is a flowchart showing the detail of the processing in a first recording mode in step S42 of the flowchart shown in FIG. 10 according to the embodiment;

FIG. 14 is a flowchart showing the detail of the processing in a second recording mode in step S62 shown in the flowchart of FIG. 11 and step S82 shown in the flowchart of FIG. 12 according to the embodiment;

FIG. 15 is a flowchart showing the interruption process set by the user according to the embodiment;

FIG. 16 is a block diagram of an example of the structure of a handheld terminal to which the image pickup apparatus according to the embodiment is applied;

FIG. 17 is a block diagram of an example of the structure of the handheld terminal externally provided with an image pickup section and an EVF display section according to the embodiment;

FIG. 18 is a block diagram of an example of the structure of a head mount display (HMD) as the image display apparatus according to the embodiment; and

FIG. 19 is a block diagram of an example of the structure of a projector as the image display apparatus according to the embodiment.

### DETAILED DESCRIPTION OF THE PREFERRED EMBODIMENT

An embodiment of the present invention will be described referring to the drawings.

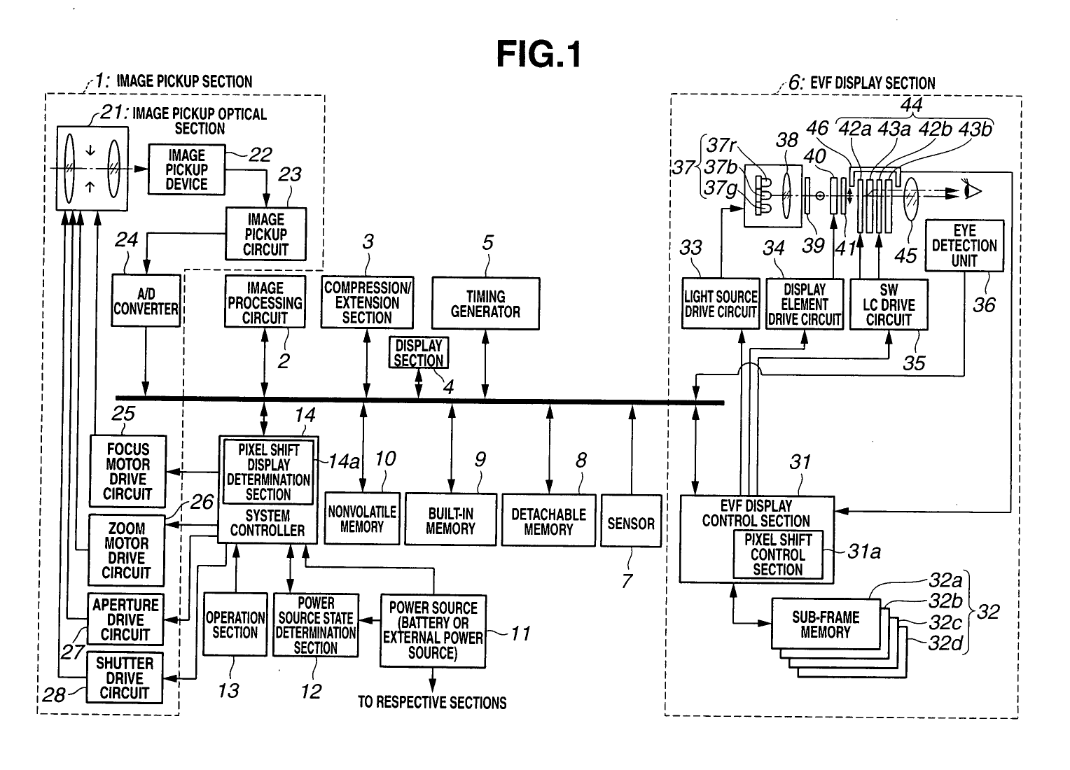

An embodiment of the present invention will be described referring to FIGS. 1 to 19. FIG. 1 is a block diagram of the structure of the image pickup apparatus provided with an EVF (Electronic View Finder) display section using the pixel shift technology.

The image pickup apparatus includes an image pickup section 1 as image pickup means, an image processing circuit 2 serving as spatial frequency analysis means and motion detection means, a compression/extension section 3 as spatial frequency analysis means, a display section 4, a timing generator 5, an EVF display section 6 as the section for displaying the extended image in the pixel shift mode, a sensor 7 as measurement means, a detachable memory 8, a built-in memory 9, a nonvolatile memory 10, a power source 11, a power source state determination section 12, an operation section 13 as operation means and detection means, and a system controller 14 as the spatial frequency analysis means and the motion detection means.

The image pickup apparatus 1 includes an image pickup optical section 21, an image pickup device 22, an image pickup circuit 23, an A/D converter 24, a focus motor drive circuit 25, a zoom motor drive circuit 26, an aperture drive circuit 27, and a shutter drive circuit 28.

The image pickup optical section 21 used for forming a subject image on the image pickup device 22 is configured including an image pickup lens as a zoom optical system, an aperture for controlling the amount of luminance flux transmitting through the image pickup lens, a mechanical shutter for controlling the time taken for the light flux to transmit through the image pickup lens, a zoom motor for driving a zoom lens of the image pickup lens, and a focus motor for driving a focus lens of the image pickup lens.

The image pickup device 22 as the CCD or CMOS, for example, photoelectrically converts the optical image of the subject formed by the image pickup optical section 21 so as to be outputted as the electric signal.

The image pickup circuit 23 drives the image pickup device 22, and converts the electric signal from the image pickup device 22 into the analog image signal so as to be outputted.

The A/D converter 24 converts the analog image signal outputted from the image pickup circuit 23 into the digital image signal (hereinafter referred to as “image information” or “image data”) so as to be outputted.

The focus motor drive circuit 25 controls and drives the focus motor of the image pickup optical section 21 for focusing the image pickup lens.

The zoom motor drive circuit 26 controls and drives the zoom motor of the image pickup optical section 21 for zooming the image pickup lens.

The aperture drive circuit 27 controls and drives the aperture of the image pickup optical section 21 for adjusting the aperture.

The shutter drive circuit 28 controls and drives the mechanical shutter of the image pickup optical section 21 for adjusting the exposure time (shutter time) of the image pickup device 22.

Operations of the respective components of the image pickup apparatus 1 are performed based on the timing signals generated by the timing generator 5 under the control of the system controller 14.

The image processing circuit 2 performs various types of image processing with respect to the image signal outputted from the A/D converter 24 and temporarily stored in the built-in memory 9 via bus. The image signal which has been processed in the image processing circuit 2 is stored in the built-in memory 9 via bus again.

The compression/extension section 3 compresses the image signal processed in the image processing circuit 2 or extends the image signal which has been compressed and already stored in the detachable memory 8 so as to be stored in the built-in memory 9.

The display section 4 displays the image processed in the image processing circuit 2, or various information data relevant to the image pickup apparatus. It may be structured to include an LCD disposed at the backside of the image pickup apparatus. The image pickup apparatus includes the display section 4 provided with the backside LCD and the EVF display section 6, both of which are controlled by the system controller 14. In other words, the system controller 14 controls the display system, for example, to enable the display section 4 while disabling the EVF display section 6, to disable the display section 4 while enabling the EVF display section 6, to enable both the display section 4 and the EVF display section 6, to disable both the display section 4 and the EVF display section 6 and the like.

The timing generator 5 generates the signal (timing signal) as a reference used for the image pickup apparatus.

The EVF display section 6 serves as an electronic view finder structured to display the high-definition image through the pixel shift technology. In the embodiment, the EVF display section 6 may be operated in such modes as a four-point pixel shift mode (one of multi-point pixel shift modes), a two-point pixel shift mode (one of multi-point pixel shift modes) each being performed in the different process, an LPF (Lowpass Filter) mode, the partial pixel shift mode, and the pixel shift OFF mode, respectively. The operations in the respective modes will be described later in detail. The EVF display section 6 includes an EVF display control section 31 as display control means, a sub-frame memory 32, a light source drive circuit 33, a display element drive circuit 34, an SW liquid crystal drive circuit 35, an eye detection unit 36 as eye detection/sensing means, a light source 37, an illumination optical system 38, a polarized plate 39, a display element 40, a polarized plate 41, a pixel shift element 44, an eye optical system 45 as expanded optical system, and a switching liquid crystal sensor unit 46.

The light source 37 is configured as a light source of three primary color frame sequential type having red color (R) LED 37r, green color (G) LED 37g, and blue color (B) LED 37b. In the embodiment, the LED is used as the light source. However, such light source as the backlight may be employed for performing the planar illumination of the display element 40. In case of subjecting the light source such as the planar backlight to the color frame sequential processing, the planar backlight using the LED as the light source may be employed. The display element 40 is formed of the monochrome type (for example, monochrome transmission type LCD) corresponding to the color frame sequential light source 37.

The pixel shift element 44 is formed of a first polarized switching liquid crystal 42a, a first birefringent plate 43a, a second polarized switching liquid crystal 42b, and a second birefringent plate 43b which are arranged on the optical path in the aforementioned order.

The EVF display control section 31 controls the respective circuits in the EVF display section 6 under the control of the system controller 14, and includes a pixel shift control section 31a for the control with respect to the pixel shifting.

The sub-frame memory 32 is formed of, for example, four sub-frame memories 32a, 32b, 32c and 32d corresponding to the respective sub-frames. The sub-frame memory 32a is used for storing image data at a pixel position A to be described later. The sub-frame memory 32b is used for storing image data at a pixel position B to be described later. The sub-frame memory 32c is used for storing image data at a pixel position C to be described later. The sub-frame memory 32d is used for storing image data at a pixel position D to be described later. The image data stored in the respective sub-frame memories 32a, 32b, 32c and 32d are formed by the pixel shift control section 31a using the image data which have been processed in the image processing circuit 2 and then stored in the built-in memory 9 so as to be written.

The light source drive circuit 33 controls the light source 37 and allows the respective LEDs to emit light in accordance with the timing for the pixel shifting under the control of the EVF display control section 31.

The display element drive circuit 34 controls to the display element 40 to display the image data of the sub-frame which have been read from any one of the sub-frame memories 32a, 32b, 32c and 32d in accordance with the pixel shift timing and transferred under the control of the EVF display control section 31.

The SW liquid crystal drive circuit 35 controls and drives the first and the second polarized switching liquid crystals 42a and 42b in accordance with the pixel shift timing under the control of the EVF display control section 31.

The eye detection unit 36 is disposed in the vicinity of the eye optical system 45 through which it is determined whether or not the user is in the observation state.

The illumination optical system 38 is used for efficiently irradiating the illumination light from the light source 37 onto the display element 40. As the incident light to the display element 40 becomes the polarized light, the PS conversion element for efficiently aligning the polarizing direction, or the optical integrator for reducing the variation in the illumination may be employed. The aforementioned components do not have to be disposed when sufficient illumination may be obtained.

The polarized plates 39 and 41 having the display element 40 interposed therebetween are disposed crossed nicols (having the polarized transmission axis orthogonally directed). The polarized plates 39 and 41 are spacially away from the display element 40 referring to FIG. 1. However, they may be bonded to the display element 40.

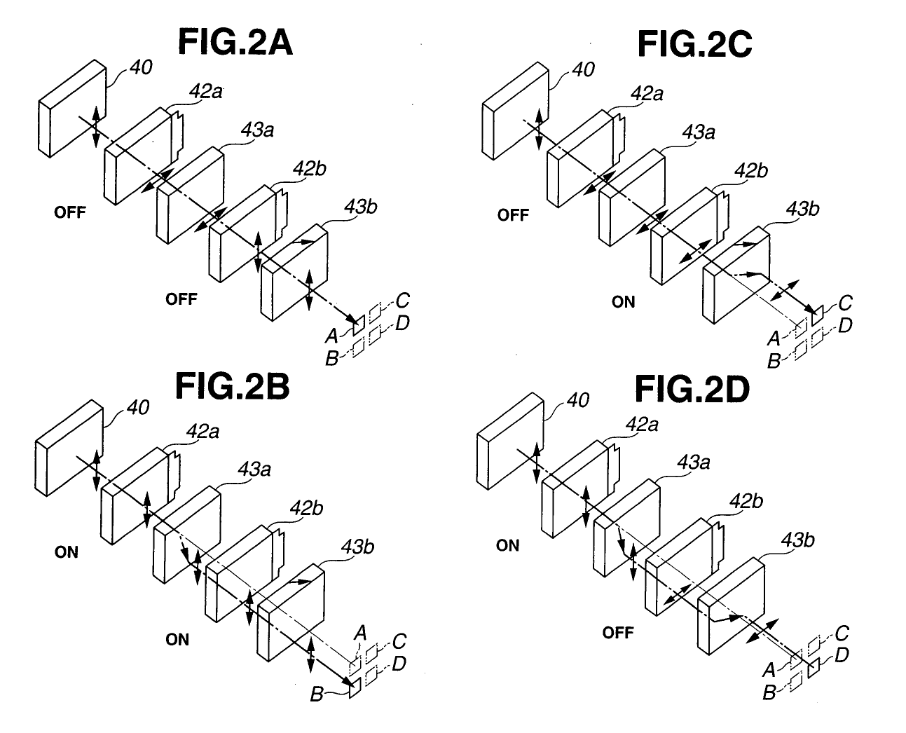

The pixel shift element 44 will be described in detail referring to FIGS. 2A to 2D.

A switching liquid crystal sensor unit 46 detects each state of the polarized switching liquid crystals 42a and 42b (response speed or the like) provided on the pixel shift element 44, and outputs the detection results to the EVF display control section 31. The EVF display control section 31 optimizes the respective drive timings based on the results of the detection performed by the switching liquid crystal sensor unit 46.

The eye optical system 45 extends the image displayed on the display element 40 and having time-series increased pixels through the pixel shift element 44 to be viewable by the observer so as to be projected as the virtual image.

Then the sensor 7 which includes the temperature sensor is used for measuring the temperature inside the image pickup apparatus, and disposed in the vicinity of the component which generates the high heat value, for example, the EVF display control section 31 or the image processing circuit 2. It is well known that in the image pickup device 22, the noise of the image is intensified as the temperature increases. Accompanied with the temperature rise in the various processing circuits, the probability of causing the operation failure may become high. It is important to keep the temperature inside the image pickup apparatus to be in the optimum range. The sensor 7 is intended to be used for measuring the temperature. The temperature measurement is described as the environmental condition herein. The other environmental conditions such as the humidity and gravitational force direction may be measured.

A detachable memory 8 is a detachable nonvolatile recording medium, for example, the memory card (SD card, xD picture card, smart media and the like), the compact hard disk for recording the image picked up by the image pickup section 1 (still image and motion image), or voice data.

The built-in memory 9 is formed of the nonvolatile memory which operates at high speeds, for example, SDRAM (Synchronous Dynamic Random Access Memory), which may be also used as the work area for processing the image as described above.

The nonvolatile memory 10 is formed as a nonvolatile recording medium such as the flash memory, and records the basic control program of the image pickup apparatus and various data relevant to the image pickup device as the computer readable recording medium for recording the processing program to control the image pickup apparatus to which the image display apparatus is applied. The system controller 14 reads the basic control program from the nonvolatile memory 10 so as to be executed, thereby controlling the entire operation of the image pickup apparatus.

The power source 11 supplies power fed from the battery or the external power source to the respective components inside the image pickup apparatus in the stable state. Generally the image pickup apparatus is driven by the battery so as to be portable. However, it may be activated upon supply of power from the external power source via the AC adaptor connected thereto.

The power source state determination section 12 determines whether power is fed to the power source 11 from the battery or the external power source. If it is determined that the power is fed from the battery, the voltage of the battery is detected to further determine with respect to the remaining level of the battery. The determination results of the power source state determination section 12 is transferred to the system controller 14.

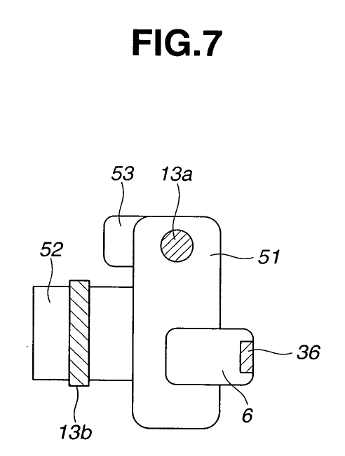

The operation section 13 includes a power switch for turning power of the image pickup apparatus ON/OFF (OFF: standby mode, ON: recording/reproduction mode), a mode selector switch for selecting the operation mode of the image pickup apparatus between the recording mode and the reproduction mode, a motion/still image selector switch for setting the motion image or the still image to be recorded in the recording mode (that is, to select between the motion image recording mode and the still image recording mode), a release button 13a (see FIG. 7) as sensing means formed of two-stage button switch for inputting the command of the image pickup operation, a focus ring 13b (see FIG. 7) as manual focus adjusting means and sensing means for manually adjusting the focus (“manual operation” includes the power driven focusing manually performed with the drive force of the motor), a button for setting the pixel shift mode in the EVF display section 6, and a cross key for various selection and moving operations.

The system controller 14 performs the central control of the image pickup apparatus based on the aforementioned basic control program, and includes a pixel shift display determination section 14a as mode set means which controls the EVF display section 6 by setting the display mode of the pixel shift thereby.

The image pickup apparatus is structured to set three operation modes, that is, a recording mode, a reproduction mode and a standby mode.

In the standby mode, the circuit required only for monitoring the operation of the power switch is operated while cutting the power supply to the other main circuits (OFF mode). The image pickup apparatus is structured to be switchable between the standby mode and any one of the recording mode and the reproduction mode (depending on the selection of the mode selector switch) through the operation of the power switch.

In the recording mode, the image pickup section 1 is allowed to pick up the image so as to be recorded upon reception of the image pickup command generated by the manual operation of the release button 13a (see FIG. 7). The recording mode includes two modes, that is, a still image recording mode and a motion image recording mode, which is switchable through the operation of the motion image/still image selector switch of the operation section 13 as described above.

In the reproduction mode, the display section 4 and the EVF display section 6 are allowed to reproduce the image without allowing the image pickup section 1 to pick up the image such that the image stored in the detachable memory 8 is reproduced to be displayed on the display section 4 or the EVF display section 6. In the reproduction mode, the image pickup operation is not performed irrespective of the operation of the release button 13a. The frame-advance reproduction may be performed upon the operation of the release button 13a while reproducing the motion image in the reproduction mode.

The mode selector switch is operated to switch between the recording mode and the reproduction mode.

In the case where a predetermined time (1 minute in the recording mode, and 3 minutes in the reproduction mode or the like) elapses in either the recording mode or the reproduction mode in the non-operational state, the mode is automatically shifted to the standby mode. In the standby mode, the operation of any switch other than the power switch may be rejected. However, the standby mode may be shifted to the selected mode (recording mode or the reproduction mode) upon the operation of the release button 13a. It is possible to arbitrarily set as a design item a switch to be operated for shifting the standby mode to the other mode. Alternatively, the user is allowed to set the shifting operation arbitrarily. The automatic shifting to the standby mode after the elapse of the predetermined time without any particular operation being performed may be made only when the power source 11 receives power from the battery. The automatic shifting is not performed when the power source 11 receives power from the external power source.

The operation for picking up an image performed by the thus structured image pickup apparatus will be described.

It is assumed that the focus of the image pickup optical section 21 is adjusted and the exposure time (shutter speed) and the aperture value are set manually or automatically based on the focus detection result and the photometric result prior to the real shooting.

When the second stage of the release button 13a is pressed, the optical image of the subject formed through the image pickup optical section 21 is converted into the electric signal by the image pickup device 22 for the set exposure time. The signal is outputted from the image pickup device 22 so as to be further converted into the analog image signal by the image pickup circuit 23.

The analog image signal is converted into the digital image signal by the A/D converter 24, and temporarily stored in the built-in memory 9.

The image processing circuit 2 performs known image processing with respect to the image information temporarily stored in the built-in memory 9, for example, pixel defect compensation, conversion processing into three image pickup signals in the case that the image pickup device 22 is a single image pickup device, the color balance processing, matrix conversion from the RGB signal to the luminance-color difference signal, the inverse conversion processing with respect to the matrix conversion, the false color elimination (or suppression) through band limitation or the like, various non-linear processing such as γ conversion, and the pixel number conversion.

The image information subjected to various processings by the image processing circuit 2 is further subjected to the processing such as JPEG compression (still image) or MPEG compression (motion image) by the compression/extension section 3 so as to be recorded in the detachable memory 8.

The picked up image may be displayed on either the display section 4 or the EVF display section 6. The picked up image intended to be displayed on the display section 4 is subjected to the image processing by the image processing circuit 2, and further to the pixel number conversion for the display section 4. When the picked up image is intended to be displayed on the EVF display section 6, the image which is subjected to the image processing by the image processing circuit 2, and temporarily stored in the built-in memory 9 is subjected to the pixel number conversion by the EVF display control section 31 so as to be recorded in the sub-frame memory 32 for each sub-frame. It is then displayed on the display element 40 via the display element drive circuit 34. At this time, the light source 37 is driven, and the polarized switching liquid crystals 42a and 42b are also driven as necessary so as to be displayed by the EVF display section 6. The operation of the EVF display section 6 will be described in detail later.

When the composition is confirmed by the display section 4 or the EVF display section 6 before picking up the still image, the frame image will be displayed thereto.

When the image which has been already recorded in the detachable memory 8 is displayed, the compressed image information is read from the detachable memory 8, and is extended by the compression/extension section 3 such that the extended image information is temporarily stored in the built-in memory 9. Then the extended image information is subjected to the predetermined image processing by the image processing circuit 2, and the processed image is displayed on the display section 4 or the EVF display section 6 in the same manner as in the shooting operation.

The system controller 14 reads the basic control program for the image pickup apparatus from the nonvolatile memory 10 to execute the control of the entire image pickup apparatus including the aforementioned process. The system controller 14 receives the input from the operation section 13 to execute the control corresponding to the input based on the basic control program. The system controller 14 determines the state of the power source 11 via the power source state determination section 12 based on the basic control program to execute the control of the entire power source while controlling the power source 11. The power source control executed by the system controller 14 includes the process for selecting the pixel shift mode for the EVF display section 6 as described later. In addition, the system controller 14 is structured to perform the focus adjustment via the focus motor drive circuit 25, the zoom adjustment via the zoom motor drive circuit 26, the aperture adjustment via the aperture drive circuit 27, and the shutter driving via the shutter drive circuit 28.

FIGS. 2A to 2D are explanatory views each showing the four-point pixel shift operation performed by the pixel shift element 44. FIGS. 2A to 2D do not show the polarized plates 39 and 41.

The polarized switching liquid crystals 42a and 42b are liquid crystal members which can be controlled to be switched between a state where the polarized direction of the incident polarized light from the display element 40 is not turned and a state where the polarized direction is turned at 90° in accordance with the ON/OFF state of the voltage applied to the polarized switching liquid crystals 42a and 42b.

The birefringent plates 43a and 43b allow the polarized lights in one of two polarized directions alternately emitted from the polarized switching liquid crystals 42a and 42b to transmit after performing the pixel shift, and allow the polarized lights in the other polarized direction to transmit without performing the pixel shift. The pixel shift amount may be set to a desired value based on the birefringence amount determined depending on the material of the birefringent plates 43a and 43b, and each thickness thereof in the optical axial direction. Once the aforementioned setting is made, the stable pixel shift amount may be obtained.

More specifically, the first birefringent plate 43a is set in the crystal direction such that the light from the display element 40 is perpendicularly shifted by ½ of the pixel pitch in the perpendicular direction of the display element 40. When the polarized direction of the incident light is perpendicular, the first birefringent plate 43a performs the pixel shift by ½ of the pixel pitch. When the polarized direction of the incident light is horizontal, it performs no pixel shift.

The second birefringent plate 43b is set in the crystal direction such that the light from the display element 40 is horizontally shifted by ½ of the pixel pitch in the horizontal direction of the display element 40. When the polarized direction of the incident light is horizontal, the second birefringent plate 43b performs the pixel shift by ½ pixel pitch, and when the polarized direction of the incident light is perpendicular, it performs no pixel shift.

The four-point pixel shift is performed by combining the above-structured two birefringent plates 43a and 43b, and ON/OFF state of the voltage application to the two polarized switching crystals 42a and 42b. That is, the combination of the polarized switching liquid crystal 42a and the birefringent plate 43a forms the pixel shift element in the perpendicular direction, and the combination of the polarized switching liquid crystal 42b and the birefringent plate 43b forms the pixel shift element in the horizontal direction. The combination of the aforementioned two pairs of the pixel shift elements realizes the pixel shift operations at four positions, that is, the pixel position A shown in FIG. 2A, the pixel position C shown in FIG. 2C, the pixel position B shown in FIG. 2B, and the pixel position D shown in FIG. 2D.

Referring to FIG. 2A, the light ray from the display element 40 travels straight to reach the pixel position A without being shifted. This state is established by turning the voltage applied to the first polarized switching liquid crystal 42a OFF, and the voltage applied to the second polarized switching liquid crystal 42b OFF. That is, when the light in the perpendicular polarized direction from the display element 40 reaches the first polarized switching liquid crystal 42a, the polarized direction is turned at 90° while passing through the first polarized switching liquid crystal 42a in OFF state, which becomes the light in the horizontal polarized direction. When the light in the horizontal polarized direction enters into the first birefringent plate 43a, it further transmits therethrough without having the pixel shifted. When the light in the horizontal polarized direction reaches the second polarized switching liquid crystal 42b, the polarized direction is turned at 90° while passing through the second polarized switching liquid crystal 42b in OFF state, which becomes the light in the perpendicular polarized direction. When the light in the perpendicular polarized direction enters into the second birefringent plate 43b, it further transmits therethrough without having the pixel shifted. The pixel position A, thus, is established.

FIG. 2C shows that the light ray from the display element 40 is shifted rightward to reach the pixel position C. This state is established by turning the voltage applied to the first polarized switching liquid crystal 42a OFF, and the second polarized switching liquid crystal 42b ON. That is, when the light in the perpendicular polarized direction from the display element 40 reaches the first polarized switching liquid crystal 42a, the polarized direction is turned at 90° while passing through the first polarized switching liquid crystal 42a in OFF state, resulting in the light in the horizontal polarized direction. When the light in the horizontal polarized direction enters into the first birefringent plate 43a, it passes therethrough without having the pixel shifted. When the light in the horizontal polarized direction reaches the second polarized switching liquid crystal 42b, the light passes through the second polarized switching liquid crystal 42b in ON state without having the polarized direction turned. When the light in the horizontal polarized direction enters into the second birefringent plate 43b, the pixel is shifted rightward in the horizontal direction by ½ pixel pitch. The pixel position C, thus is established.

Referring to FIG. 2B, the light ray from the display element 40 is shifted downward to reach the pixel position B. This state is established by turning the voltage applied to the first polarized switching liquid crystal 42a ON, and the voltage applied to the second polarized switching liquid crystal 42b ON. When the light in the perpendicular polarized direction from the display element 40 reaches the first polarized switching liquid crystal 42a, it passes through the first polarized switching liquid crystal 42a in ON state without having the polarized direction turned. When the light in the perpendicular polarized direction enters into the first birefringent plate 43a, the pixel shift is performed in the perpendicular downward direction by ½ pixel pitch. When the light in the perpendicular polarized direction reaches the second polarized switching liquid crystal 42b, it passes through the second polarized switching liquid crystal 42b in ON state without having the polarized direction turned. When the light in the perpendicular polarized direction enters into the second birefringent plate 43b, it passes therethrough without having the pixel shifted. The pixel position B, thus, is established.

Referring to FIG. 2D, the light ray from the display element 40 is shifted to the right downward direction to reach the pixel position D. This state is established by turning the voltage applied to the first polarized switching liquid crystal 42a ON, and the voltage applied to the second polarized switching liquid crystal 42b OFF. When the light in the perpendicular polarized direction from the display element 40 reaches the first polarized switching liquid crystal 42a, it passes therethrough without having the polarized direction turned. When the light in the perpendicular polarized direction enters into the first birefringent plate 43a, the pixel shift is performed in the perpendicular downward direction by ½ pixel pitch. When the light in the perpendicular polarized direction reaches the second polarized switching liquid crystal 42b, the polarized direction is turned at 90° while passing through the second polarized switching liquid crystal 42b in OFF state, resulting in the light in the horizontal polarized direction. When the light in the horizontal polarized direction enters into the second birefringent plate 43b, the pixel shift is performed in the horizontal rightward direction by ½ pixel pitch. The pixel position D, thus, is established.

The pixel position may be selected from four positions A to D by combining the ON/OFF state of the voltages applied to the first and the second polarized switching liquid crystals 42a and 42b.

Any type of the liquid crystal, for example, TN liquid crystal and ferroelectric liquid crystal may be employed as the polarized switching liquid crystals 42a and 42b so long as it is switchable between the state where the polarized direction of the incident light is turned at 90° and the state where the polarized direction is not turned. The TN (Twisted Nematic) liquid crystal is suitable for the use as it can be easily purchased at a low cost and has a stable performance. In the embodiment, the TN liquid crystal is employed.

Each of the birefringent plates 43a and 43b is formed into a plate using the anisotropic crystal such as quartz (α-SiO₂), lithium niobate (LiNbO₃), rutile (TiO₂), calcite (CaCo₃), nitratine (NaNo₃), and YVO₄. It is preferable to use the quartz because of the low cost. However, the lithium niobate with high refraction factor may be used for the compact structure.

The polarized switching liquid crystals 42a and 42b, and the birefringent plates 43a and 43b may be coated with the antireflection material for the purpose of improving the light transmittance and preventing degradation of the image quality caused by the ghost or flare.

The process for increasing the pixels of the displayed image (improving the resolution) using the aforementioned pixel shift element 44 will be described.

The image information stored in the built-in memory 9 (which may be picked up by the image pickup section 1 and processed by the image processing circuit 2, or read from the detachable memory 8 to be extended by the compression/extension section 3 and processed by the image processing circuit 2) is converted into the image information with the pixel number four times more than that of the display element 40 by the pixel shift control section 31a (in the case of four-point pixel shift). The pixel shift control section 31a divides the converted image information into four sub-frame images to be displayed at the respective pixel positions A to D. The sub-frame image at the pixel position A is stored in the sub-frame memory 32a, the sub-frame image at the pixel position B is stored in the sub-frame memory 32b, the sub-frame image at the pixel position C is stored in the sub-frame memory 32c, and the sub-frame image at the pixel position D is stored in the sub-frame memory 32d, respectively. The pixel shift control section 31a drives the display element 40 via the display element drive circuit 34 to display the sub-frame images in the order of the pixel position A, C, B and D, and controls the polarized switching liquid crystals 42a and 42b via the SW liquid crystal drive circuit 35 to shift the light ray (pixel shift) in the order of the pixel position A, C, B, and D. The pixel shift at the pixel position A is performed in synchronization with the display of the sub-frame image at the pixel position A. The pixel shift at the pixel position B is performed in synchronization with the display of the sub-frame image at the pixel position B. The pixel shift at the pixel position C is performed in synchronization with the display of the sub-frame image at the pixel position C. The pixel shift at the pixel position D is further performed in synchronization with the display of the sub-frame image at the pixel position D.

The liquid crystal has a certain temperature property, for example, the one with respect to the response speed. The response speed becomes low at the low temperature and it becomes high at the high temperature. The aforementioned temperature property may change the operation timings of the display element 40, and the polarized switching liquid crystals 42a and 42b, resulting in the risk that the intended performance cannot be obtained. Especially, the product expected to be used outdoors, for example, the digital camera and the digital video camera may be exposed to the low temperature environment.

A switching liquid crystal sensor unit 46 for detecting the property of the pixel shift element 44 is disposed in the vicinity of the pixel shift element 44 so as to allow the pixel shift control section 31a to control the pixel shift element 44 and the display element 40 in accordance with the detected property. The pixel shift control section 31a grasps the states of the polarized switching liquid crystals 42a and 42b real-time based on the output of the switching crystal sensor unit 46, and controls the drive timing of the polarized switching liquid crystals 42a and 42b, and the display timing of the display element 40 in accordance with the grasped states, thus maintaining the high quality image irrespective of the change in the temperatures of the polarized switching liquid crystals 42a and 42b.

The switching liquid crystal sensor unit 46 includes the light source, the polarized plate for converting the light source into the polarized light, and the light receiving element (photo diode: PD). The light source and the light receiving element are arranged to interpose the polarized switching liquid crystals 42a and 42b. The light receiving amount of the light receiving element is structured to vary in accordance with the drive states (state of the applied voltage) of the polarized switching liquid crystals 42a and 42b. The response properties of the polarized switching liquid crystals 42a and 42b may be constantly grasped by monitoring the light receiving amount.

FIG. 1 shows an example where the switching liquid crystal sensor unit 46 is disposed for performing the optical measurement. The temperature sensor may be provided instead of the switching liquid crystal sensor unit 46 or in addition thereto in the vicinity of the pixel shift element 44 such that the drive timings of the polarized switching liquid crystals 42a and 42b are adjusted in accordance with the measured temperature (as for the details with respect to the technology with the temperature sensor, see Japanese Unexamined Patent Application publication No. 11-326877).

The embodiment employs the process for obtaining the color image having R, G and B images time-series superimposed (color frame sequential display type) by displaying images of the RGB colors on the display element 40 of monochrome type in synchronization with the illumination of the RGB colors. The sub-frame image at the single pixel position is formed of the sub-frame images of R, G and B. It is required to adjust the timing between the light source 37 and the display element 40 at each pixel position.

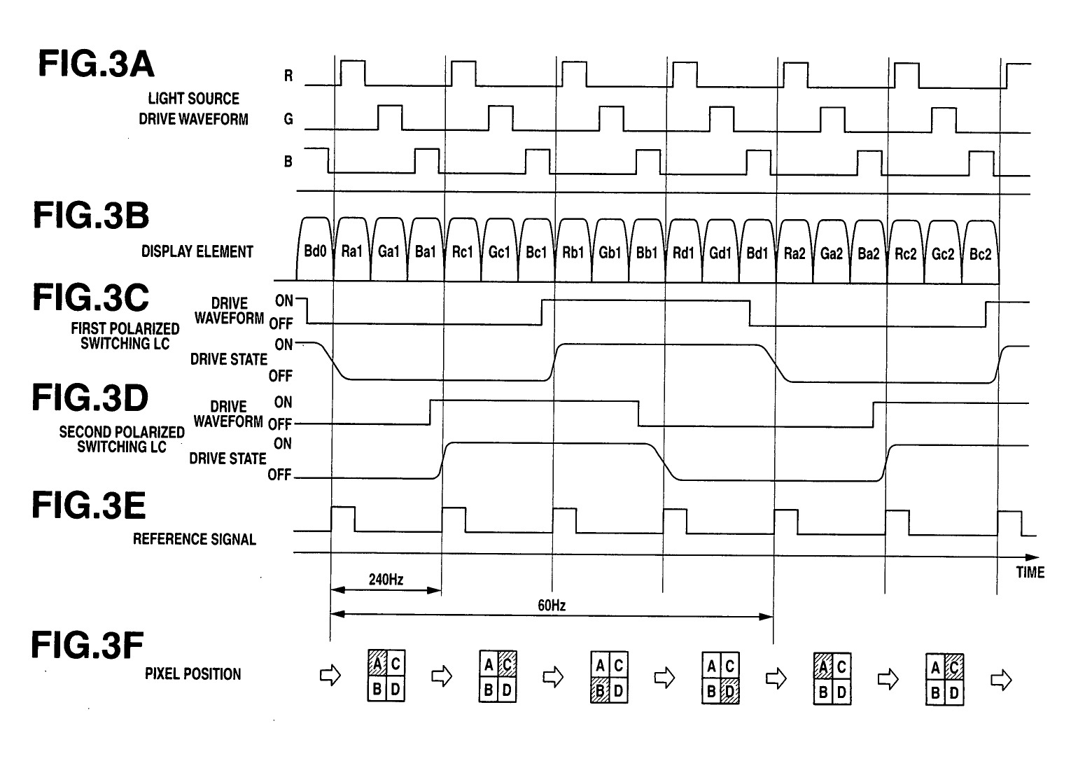

The timing for the pixel shift display will be described referring to FIGS. 3A to 3F. FIGS. 3A to 3F are timing charts showing the respective driving operations of the light source 37, the display element 40, and the polarized switching liquid crystals 42a and 42b in the four-point pixel shift mode.

FIG. 3A shows the drive waveforms of the red (R) LED 37r, the green (G) LED 37g, and blue (B) LED 37b of the light source 37. FIG. 3B shows the switching waveform of the display element 40. FIG. 3C shows the switching waveform of the first polarized switching liquid crystal 42a. FIG. 3D shows the switching waveform of the second polarized switching liquid crystal 42b. FIG. 3E shows the reference signal. FIG. 3F shows the pixel positions established by the pixel shift operation.

The arbitrary pixel position among those at A, C, B and D is displayed at the cycle of 240 Hz (sub-frame cycle) in the driving operation shown in FIGS. 3A to 3F. The single cycle (frame cycle) of the four-point pixel shift mode which makes the circuit through the four pixel positions in order of A, C, B and D is controlled to be set to 60 Hz.

The pixel shift control section 31a generates the perpendicular synchronization signal at 240 Hz as the reference signal for synchronization as shown in FIG. 3E upon the pixel shift operation based on the timing signal inputted from the timing generator 5. The reference signal for the pixel shift mode is commonly used as the reference signal for the image pickup operation so as to allow the image display conforming to the image pickup timing. This makes it possible to prevent the difference between the image pickup timing and the display timing. In the embodiment, the pixel shift control section 31a generates the reference signal based on the timing signal generated by the timing generator 5. When the reference signal does not conform to the image pickup timing, the pixel shift control section 31a may be structured to generate the new timing signal.

In the embodiment where the color frame sequential display process is employed, the pixel shift control section 31a controls the light source 37 via the light source drive circuit 33 at the single pixel position. The R sub-frame image, G sub-frame image and B sub-frame image are displayed on the display element 40 in synchronization with emission of the light in the colors R, G and B, respectively (see FIGS. 3A and 3B). As the sub-frame is displayed at 240 Hz in synchronization with the reference signal as described above, the sub-frame of each color, that is, R sub-frame, G sub-frame and B sub-frame will be displayed at 720 Hz (It is not always equally time displayed because of the difference in the light amount of the light source). The cycle for displaying the sub-frame of the particular color is 240 Hz, that is, it is displayed once at 1/240 seconds.

In the embodiment, the single frame is displayed at 60 Hz, and the sub-frames of the respective colors are displayed at 720 Hz. It is possible to display the single frame at 30 Hz, and the sub-frames of the respective colors at 360 Hz. It is preferable to display the sub-frames of the respective colors at 480 Hz or higher for the purpose of suppressing the color breaking (color breakup), and the oscillation or flickering of the image caused by the pixel shift operation.

The image information of the single frame will be displayed by the sub-frames, that is, the R sub-frame Ra1, the G sub-frame Ga1 and the B sub-frame Ba1 at the pixel position A, the R sub-frame Rc1, the G sub-frame Gc1, and the B sub-frame Bc1 at the pixel position C, the R sub-frame Rb1, the G sub-frame Gb1, and the B sub-frame Bb1 at the pixel position B, and the R sub-frame Rd1, the G sub-frame Gd1 and the B sub-frame Bd1 at the pixel position D sequentially in the order as shown in FIGS. 3F and 3B.

The sub-frame memory 32 may be updated at an appropriate timing. When the frame is required to be switched at 60 Hz in the recording mode (for example, for displaying the through image), the sub-frame memory 32 is updated for each frame. When the image is not required to be switched for each frame in the reproduction mode (for example, for displaying the still image), the same display may be performed while holding the image information without updating the sub-frame memory 32.

In the embodiment, the pixel position is shifted in the order of A, C, B and D as shown in FIG. 3F, the first polarized switching liquid crystal 42a is driven OFF, OFF, ON and ON for each sub-frame. The second polarized switching liquid crystal 42b is driven OFF, ON, ON, and OFF for each sub-frame. Referring to FIGS. 2A to 2D, combinations of the drive states of the first and the second polarized switching liquid crystals 42a and 42b are (OFF, OFF), (OFF, ON), (ON, ON), and (ON, OFF), respectively for each sub-frame.

In the embodiment, the TN liquid crystals are employed as the polarized switching liquid crystals 42a and 42b. It is known that the response property of the TN liquid crystal changes depending on ON/OFF state of the voltage. As shown in FIGS. 3C and 3D, upon the transition of the voltage state from ON to OFF, the change in the drive state is relatively gentle, and from OFF to ON, the change in the drive state is relatively sharp. It is required to determine the respective waveforms in consideration with the response speed of each of the polarized switching liquid crystals 42a and 42b for the purpose of allowing the pixel shift element 44 to perform the intended operation conforming to the display timing of the display element 40. The drive waveform relative to the reference signal is delayed (actually to the front side) by the pixel shift control section 31a at the time point where the reference signal rises up as shown in FIG. 3E such that the drive states of the polarized switching liquid crystals 42a and 42b become the intermediate state (see correlation between the drive states of the respective polarized switching liquid crystals 42a and 42b, and the drive waveform as shown in FIGS. 3C and 3D).

The RGB illumination of the light source 37, the display element 40, the polarized switching liquid crystals 42a and 42b are driven at the aforementioned timings in reference to the reference signal to realize the four-point pixel shift (display the image with the number of pixels four times more than that of the display element 40) while performing the color frame sequential display.

The image information with the number of pixels four times more than that of the display element 40 is required to be processed to perform the aforementioned four-point pixel shift. Accordingly, the number of pixels to be processed by the image processing circuit 2 becomes four times more than that of the display element 40 to display the normal frame image (that is, the load of the image processing circuit 2 becomes four times higher). The display element 40 is further required to be driven at the sub-frame rate of 240 Hz which is four times higher than the normal frame rate of 60 Hz. The aforementioned change in the number of the pixels or processing speed to be increased by four times may apply to the other relevant circuits. When the pixel shift display is performed, more power is required compared with the display with no pixel shift operation. In the case where the battery driven image display apparatus is the image pickup apparatus such as the digital camera, the power for the image display operation should be suppressed as it is intended to be used for the image pickup operation as the main function. It is therefore required to minimize the pixel shift operation. From the aforementioned point of view, in the present embodiment, the pixel shift operation is suppressed, which will be described in detail later.

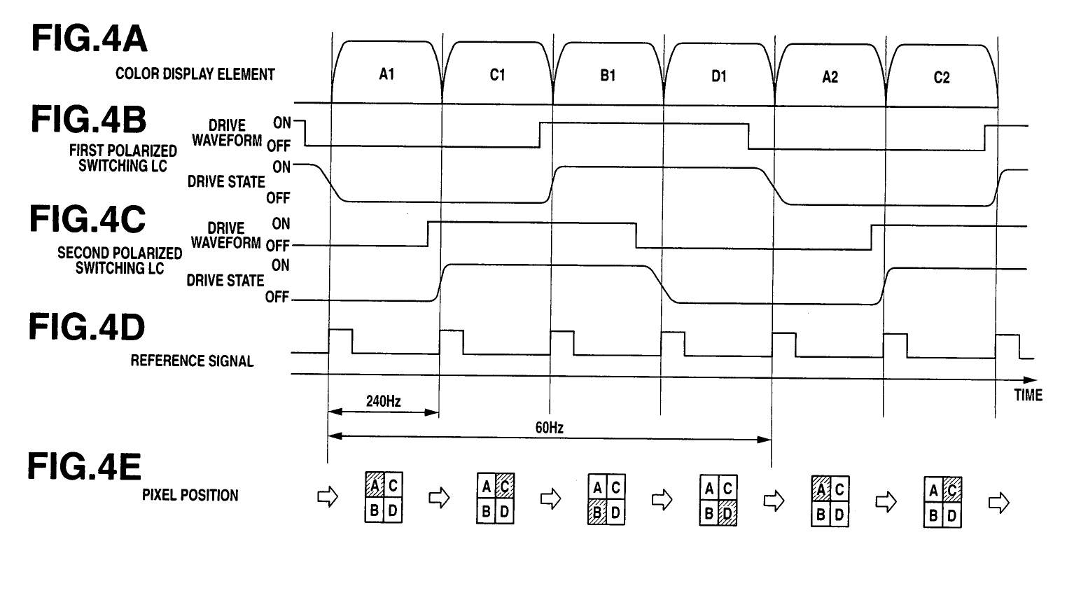

The color frame sequential display mode using the display element 40 of monochrome type has been described. However, the present invention is not limited to the aforementioned structure. The example of the pixel shift display using the display element of color type where the Bayer-type primary color filter is arranged will be described referring to FIGS. 4A to 4E. FIGS. 4A to 4E are timing charts showing the respective drive states of the color display element, and the polarized switching liquid crystals 42a and 42b in the four-point pixel shift mode.

In this case, any light source is usable so long as it is the white frame light source, and the light source may be kept in the constant illuminated state. The timing charts in FIGS. 4A to 4E do not show the drive waveforms of the light source. More specifically, FIG. 4A shows the switching waveform of the color display element. FIG. 4B shows the switching waveform of the first polarized switching liquid crystal 42a. FIG. 4C shows the switching waveform of the second polarized switching liquid crystal 42b. FIG. 4D shows the reference signal. FIG. 4E shows the pixel position corresponding to the pixel shift operation.

The timing charts of FIGS. 4A to 4E are different from those of FIGS. 3A to 3E in that the color display element is driven by the unit of sub-frame, thus requiring no time division into the respective colors in the single sub-frame. Upon the pixel shift at the pixel position A, the sub-frame image A1 corresponding to the pixel position A is displayed. Upon the pixel shift at the pixel position C, the sub-frame image C1 corresponding to the pixel position C is displayed. Upon the pixel shift at the pixel position B, the sub-frame image B1 corresponding to the pixel position B is displayed. Upon the pixel shift at the pixel position D, the sub-frame image D1 corresponding to the pixel position D is displayed. Other features are basically the same as those of the timing charts shown in FIGS. 3A to 3F.

The pixel shift display may be performed with the color display element in the same manner as the color frame sequential display with the monochrome display element.

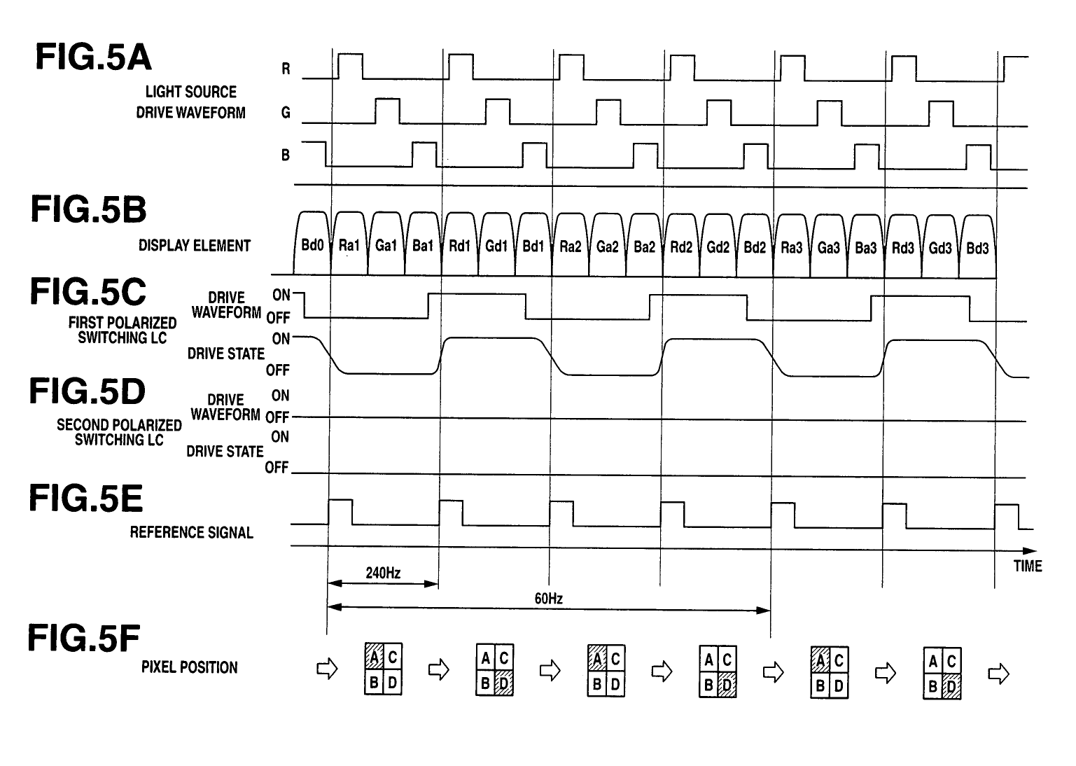

FIGS. 5A to 5F are timing charts showing drive states of the light source 37, the display element 40 and the polarized switching liquid crystals 42a and 42b in the two-point pixel shift mode.

In the two-point pixel shift mode, only two pixel positions at the diagonal position, for example, positions A and D are shifted. The pixel shift control section 31a generates the image information with the number of pixels two times (the power consumption is reduced compared with the generation of the image information with the number of pixels four times) more than that of the display element 40 based on the image information stored in the built-in memory 9. The generated image information is further divided into the sub-frame images corresponding to the pixel positions A and D so as to be stored in the sub-frame memories 32a and 32d, respectively. The pixel shift control section 31a drives the display element 40 via the display element drive circuit 34 to display the sub-frame image at the pixel positions A and D sequentially, and controls the polarized switching liquid crystals 42a and 42b via the SW liquid crystal drive circuit 35 to perform the light ray shift (pixel shift) at the positions A and D sequentially in the order. The aforementioned pixel shift is established by driving the first polarized switching liquid crystal 42a OFF and then ON sequentially while keeping the second polarized switching liquid crystal 42b in the constant OFF state.

When the sub-frame frequency is kept at 240 Hz, the frame period becomes 120 Hz. In this case, the display will be performed at the double speed. The display may be performed at the normal speed in two methods as follows. In the first method, the sub-frame period is set to 120 Hz to set the frame frequency to 60 Hz such that the light source 37 and the display element 40 are driven in the cycle at the sub-frame period of 120 Hz. In the second method, the sub-frame image at the pixel position A is displayed using the first and the third sub-frames, and the sub-frame image at the pixel position D is displayed using the second and the fourth sub-frames while keeping the sub-frame period at 240 Hz. In this case, the frame period may be set to 60 Hz. Any one of the aforementioned methods may be employed. However, the second method is more compatible with the four-point pixel shift operation, resulting in the less complicated control operation.

In the two-point pixel shift mode, the number of pixels processed by the image processing circuit 2 becomes half the number of pixels for the four-point pixel shift, and the second polarized switching liquid crystal 42b may be kept OFF. This makes it possible to markedly reduce the power consumption compared with the four-point pixel shift mode.

The pixel positions A and D are selected as those for the two-point pixel shift mode. However, not being limited thereto, the pixel positions B and C (the other diagonal arrangement), A and C (horizontal direction), B and D (horizontal direction), A and B (perpendicular direction), and C and D (perpendicular direction) may be selected. The selection of the positions may be made depending on the requirement to improve the resolution (number of pixels) of the display image in the desired direction.

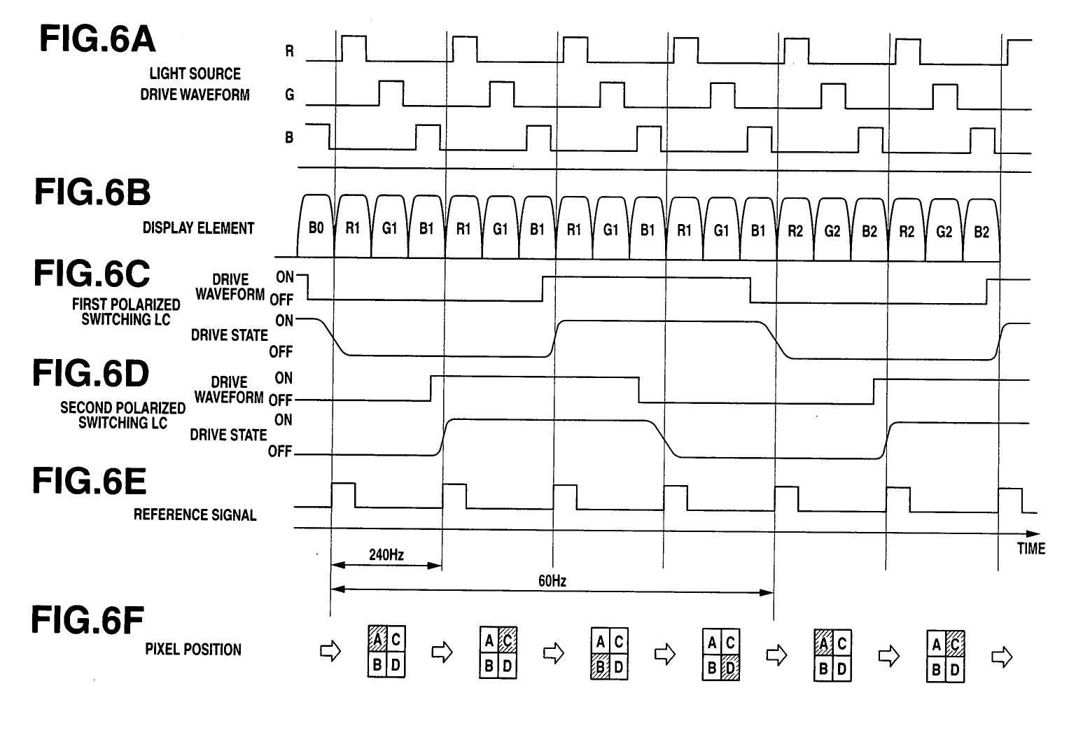

FIGS. 6A to 6F are timing charts showing the drive states of the light source 37, the display element 40, and the polarized switching liquid crystals 42a and 42b in the LPF mode.

In the LPF mode, the pixel shift element 44 is driven in the same manner as in the four-point pixel shift mode, and the image displayed on the display element 40 is formed into the frame image for the unit of frame (unit of 60 Hz). In this mode, the same frame image is displayed in four sub-frames. In the LPF mode, the pixel shift control section 31a generates the image information with the same number of pixels as that of the display element 40 based on the image information stored in the built-in memory 9. The thus generated image information is further stored in any one of the sub-frame memories, or all the sub-frame memories 32a to 32d. When the image information is stored in all the sub-frame memories 32a to 32d, the image may be displayed under the same control as that in the four-point pixel shift mode. When the image information is stored in only one of the sub-frame memories, the time for transferring the image may be made somewhat shorter.

The EVF display section 6 is operated in the same manner as in the four-point pixel shift mode shown in FIGS. 3A to 3F in the four sub-frames except that the same frame image is displayed on the display element 40.

In the LPF mode, the number of pixels processed by the image processing circuit 2 is reduced by ¼ of that for the four-point pixel shift mode so as to markedly reduce the power required for processing and transferring the image. In the LPF mode, the area where the pixel is not displayed is reduced (apparent opening ratio is improved) compared with the pixel shift OFF mode, and the display rate is high enough to be unsusceptible to the effect of the flickering, resulting in the improved quality of the displayed image.

The EVF display section 6 is structured to be operated in the partial pixel shift mode. In the partial pixel shift mode, the pixel shift over the entire screen is not performed, but the pixel shift with respect to the portion of the screen is performed (the four-point pixel shift mode or the two-point pixel shift mode in the embodiment). The pixel shift over the entire screen will be performed in the same way as in the LPF mode (the operation is substantially the same as the one shown in FIGS. 6A to 6F) except that the image to be displayed on the display element 40 becomes partially different for each of the sub-frames. In the four-point pixel shift mode, the image data corresponding to the pixel positions A, C, B and D are generated with respect to the portion where the high-definition display is required (as a portion of the screen determined to have the high frequency component based on the spatial frequency analysis as described later). As the partially different sub-frame images are displayed on the display element 40, the entire screen is displayed in the LPF mode while partially performing the four-point pixel shift display. In this case, the image data required to be processed for the single frame is derived from the equation of (number of pixels of the display element 40)+(4−1)×(the number of pixels of the pixel shift portion to be displayed for the single sub-frame). If the pixel shift portion is not so large, the high-definition image may be displayed without much increasing the load to the processing.

The EVF display section 6 is structured to be operated in the pixel shift OFF mode. The pixel shift OFF mode may be realized through various methods, and two exemplary cases will be described hereinafter. The polarized switching liquid crystals 42a and 42b are kept in OFF states in any of the methods. In the first method, the light source 37 is illuminated for the respective RGB colors each at 180 Hz in the single frame at 60 Hz such that the R frame corresponding to the single frame is displayed on the display element 40 for the period of illuminating the R color, the G frame corresponding to the single frame is displayed on the display element 40 for the period of illuminating the G color, and the B frame corresponding to the single frame is displayed on the display element 40 for the period of illuminating the B color, respectively. In the second method, basically the same operation of the LPF mode shown in FIGS. 6A to 6F is performed while setting the drive states of the polarized switching liquid crystals 42a and 42b to OFF states. The first method reduces the power consumption while elongating the drive cycle. Meanwhile, the second method is highly compatible with the four-point pixel shift operation to suppress the effect of the flickering without complicating the control operation.

As described above, the image information stored in the built-in memory 9 is used to generate the image information with respect to each number of pixels corresponding to the four-point pixel shift mode, the two-point pixel shift mode, the partial pixel shift mode, the LPF mode, and the pixel shift OFF mode, respectively. Alternatively, the image information with respect to the number of pixels corresponding to the four-point pixel shift mode is generated first for all the modes (that is, the image information at the pixel positions A to D). In the two-point pixel shift mode, only the image information at the pixel positions A and D may be used, and in the LPF mode and the pixel shift OFF mode, the image information at the pixel position A (or the image information with the average value of those at the pixel positions A to D) may only be used. In the aforementioned case, it is preferable to perform various image processing with respect only to the image information intended to be used for the purpose of reducing the power consumption. This allows the transition to the other pixel shift mode to be easily made for the aforementioned processing.

In the respective pixel shift modes, a pixel shift display determination section 14a in the system controller 14 is structured to select the appropriate mode depending on the power source state, the user's command via the operation section 13, and whether the image to be reproduced is the still image or the motion image, and further to set the mode and operate the EVF display section 6 via the EVF display control section 31. The aforementioned control operation will be described in detail later.

FIG. 7 is a plan view showing the structure for detecting whether or not the image pickup apparatus is in use.

The image pickup apparatus includes a lens barrel 52 which protrudes from the center on the front surface of a main body 51, and a grip portion 53 gripped by the user's right hand to grasp the image pickup apparatus at the right side of the main body 51. The EVF display section 6 is disposed on the upper surface of the main body 51.

The release button 13a configuring the operation section 13 is disposed on the upper surface of the main body 51 at the position where it is possible to be depressed by the index finger of the right hand of the user who is grasping the grip portion 53. The release button 13a is formed as the two-staged push button, having the first stage to be depressed to allow the AF or AE operation, and the second stage to be depressed to allow the image pickup operation. The determination whether or not the user is intended to operate the image pickup apparatus to pick up an image may be made based on the detection of the depression state of the release button 13a (see Japanese Unexamined Patent Application Publication No. 2-112120). The sensor (sensing means) may be installed in the grip portion 53 to detect whether or not the user has grasped the grip portion 53 (see Japanese Unexamined Patent Application Publication No. 5-207339).

As the focus ring 13b configuring the operation section 13 is disposed in the lens barrel 52, the rotating state of the focus ring 13b is detected to allow the determination whether or not the user is intended to operate the image pickup apparatus to perform the manual focusing (see Japanese Unexamined Patent Application Publication No. 9-18769).

The eye detection unit 36 is disposed in the vicinity of an eye optical system 45 of the EVF display section 6. The eye detection unit 36 is used for determining whether the user has been observing via the EVF display section 6 (for example, see Japanese Unexamined Patent Application Publication No. 5-207339).

The detection results with respect to the user operation state may be used for setting the pixel shift mode to suppress the power consumption.

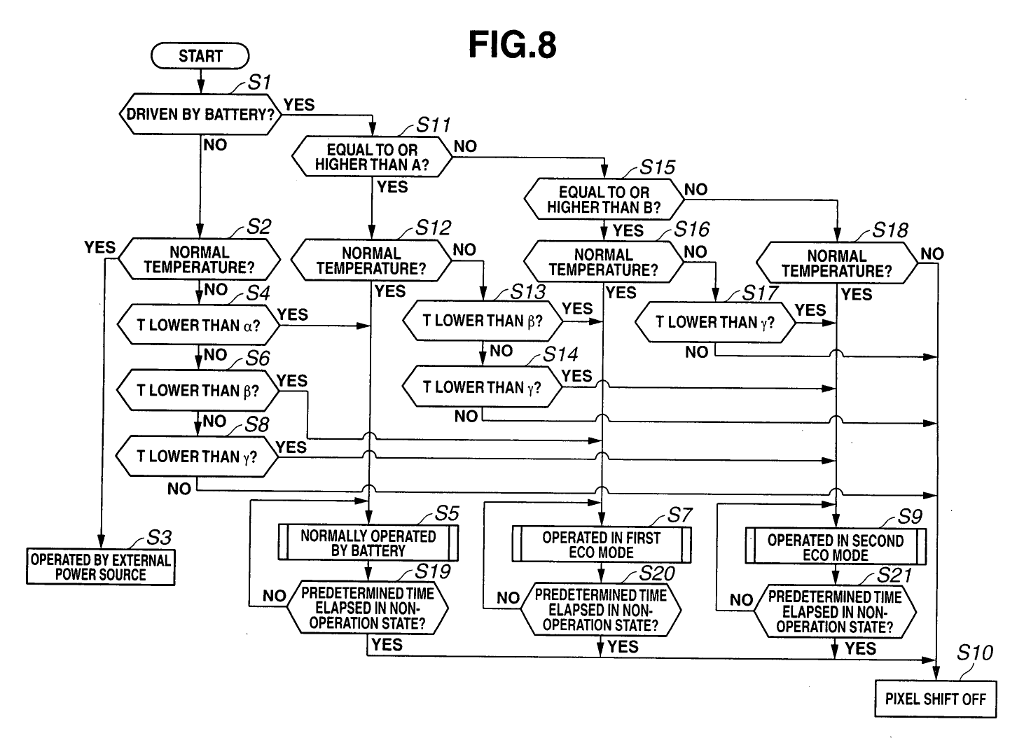

The operation for suppressing the power consumption by controlling the display mode with respect to the pixel shift operation in the image pickup apparatus will be described referring to FIGS. 8 to 15.

FIG. 8 is a flowchart showing bifurcation of operations performed in the image pickup apparatus depending on the power source state and the temperature.

Upon start of the routine, the pixel shift display determination section 14a of the system controller 14 determines whether the power source 11 is driven by the battery or by the external power source (the image pickup apparatus is driven by the battery or the external power source) based on the output from the power source state determination section 12 in step S1.

When it is determined that the image pickup apparatus is not driven by the battery, that is, it is driven by the external power source, the temperature is compared with the predetermined threshold value determined as the normal temperature so as to determine whether or not the temperature is normal based on the output from the sensor 7 in step S2.

When it is determined that the temperature is normal, the apparatus is activated by the external power source in step S3.

When it is determined that the temperature is not normal in step S2, the temperature is further compared with the predetermined temperature a which exceeds the normal temperature range so as to determine whether or not the temperature detected by the sensor 7 is lower than the predetermined temperature a in step S4.

When it is determined that the temperature is lower than the predetermined temperature α, the image pickup apparatus is activated by the battery to be described later in step S5.

When it is determined that the temperature is equal to or higher than the predetermined value α in step S4, it is determined whether the temperature is lower than a predetermined temperature β which is higher than the temperature α (that is, α<α) in step S6.

When it is determined that the temperature is lower than the predetermined temperature β, the image pickup apparatus is activated in a first economy mode (hereinafter referred to as the first eco mode) in step S7.

In step S6, when it is determined that the temperature is equal to or higher than the predetermined temperature β, it is further determined whether or not the temperature is lower than a predetermined temperature γ which is higher than the temperature β (α<β<γ) in step S8.

When it is determined that the temperature is lower than the predetermined temperature γ, the image pickup apparatus is activated in the second economy mode (hereinafter referred to as the second eco mode) in step S9.

When it is determined that the temperature is equal to or higher than the predetermined temperature γ, the operation is performed in the pixel shift OFF mode in step S10.

Meanwhile in step S1, when it is determined that the image pickup apparatus is driven by the battery, the pixel shift display determination section 14a determines whether or not the remaining level of the battery is equal to or higher than a predetermined value A which is sufficient for operating the normal battery operation in step S5 based on the output from the power source state determination section 12 in step S11.

When it is determined that the remaining level of the battery is equal to or higher than the predetermined value A, it is further determined whether or not the temperature is normal based on the output from the sensor 7 in step S12.

When it is determined that the temperature is normal, the process proceeds to step S5 where the normal battery operation is performed to be described later.

In step S12, when it is determined that the temperature is not normal, it is further determined whether or not the temperature is lower than the predetermined temperature β in step S13.

When it is determined that the temperature is lower than the predetermined temperature β, the process proceeds to step S7 where the operation in the first eco mode is performed.

When it is determined that the temperature is equal to or higher than the predetermined temperature β in step S13, it is further determined whether or not the temperature is lower than the predetermined temperature γ in step S14.

When it is determined that the temperature is lower than the predetermined temperature γ, the process proceeds to step S9 where the operation in a second eco mode is performed.

In step S14, when it is determined that the temperature is equal to or higher than the predetermined temperature γ, the process proceeds to step S10 where the operation in the pixel shift OFF mode is performed.

In step S15, when it is determined that the remaining level of the battery is lower than the predetermined value A in step S11, the pixel shift display determination section 14a determines whether or not the remaining level of the battery is equal to or higher than a predetermined value B (A>B) sufficient to perform the operation in the first eco mode in step S7.

When it is determined that the remaining level of the battery is equal to or higher than the predetermined value B, it is further determined whether or not the temperature is normal based on the output from the sensor 7 in step S16.

When it is determined that the temperature is normal, the process proceeds to step S7 where the operation in the first eco mode is performed.

In step S16, when it is determined that the temperature is not normal, it is determined whether or not the temperature is lower than the predetermined temperature γ in step S17.

When it is determined that the temperature is lower than the predetermined temperature γ, the process proceeds to step S9 where the operation in the second eco mode is performed.

In step S17, when it is determined that the temperature is equal to or higher than the predetermined temperature γ, the process proceeds to step S10 where the operation in the pixel shift OFF mode is performed.

In step S15, when it is determined that the remaining level of the battery is lower than the predetermined value B, it is further determined whether or not the temperature is normal based on the output from the sensor 7 in step S18.

When it is determined that the temperature is normal, the process proceeds to step S9 where the operation in the second eco mode to be described later is performed.

In step S18, when it is determined that the temperature is not normal, the process proceeds to step S10 where the display in the pixel shift OFF mode is performed.

During the normal battery operation in step S5, it is monitored whether or not a predetermined time elapses in the non-operation state at predetermined time intervals in step S19. When it is monitored that the predetermined time has not been elapsed yet, the normal battery operation in step S5 is continued.

During execution of the operation in the first eco mode in step S7, it is monitored whether or not the predetermined time elapses in the non-operation state at predetermined time intervals in step S20. When it is monitored that the predetermined time has not been elapsed yet, the operation in the first eco mode in step S7 is continued.

During execution of the operation in the second eco mode in step S9, it is monitored whether or not the predetermined time elapses in the non-operation state at predetermined time intervals in step S21. When it is monitored that the predetermined time has not been elapsed yet, the operation in the second eco mode in step S9 is continued.

When it is determined that the predetermined time has elapsed in step 19, 20 or 21, the process proceeds to step S10 where the display in the pixel shift OFF mode is performed. The predetermined time set in steps S19, S20 and S21 may be different. Each predetermined time in steps S19, S20 and S21 is shorter than the predetermined time for automatic transition to the standby mode when the image pickup apparatus is in the non-operational state.

The user is allowed to select the reference time for the transition to the display in the pixel shift OFF mode in the non-operational state via the operation section 13 from the menu displayed on the display element 4 or the EVF display section 6.

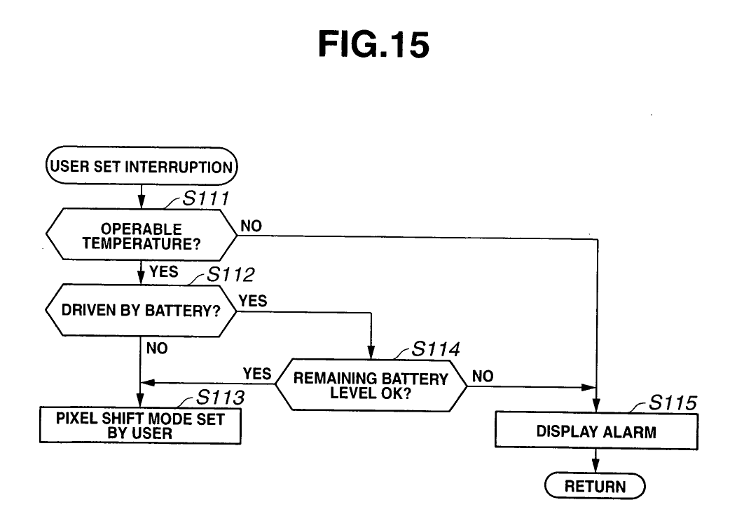

When some sort of operation is performed after the transition to the pixel shift OFF mode, the structure may be formed to return to the display mode prior to the transition to the pixel shift OFF mode. As the user set interruption process (see FIG. 15) is effective in the pixel shift OFF mode, the user is allowed to select the desired display mode.

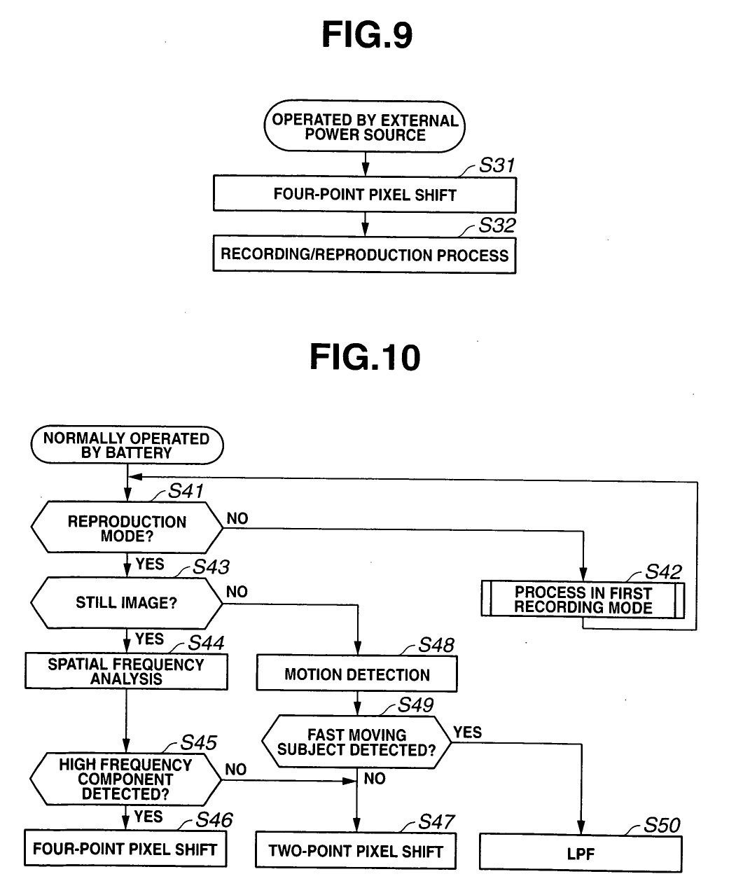

FIG. 9 shows the flowchart of the operation with the external power source performed in step S3 shown in FIG. 8 in detail.

Upon start of the routine, the display mode of the EVF display section 6 is set to the four-point pixel shift mode as shown in FIGS. 2A to 2D and FIGS. 3A to 3F (see FIGS. 4A to 4E when the color display element is used as the display element) in step S31.

Thereafter, the image picked up by the image pickup apparatus is recorded and reproduced in step S32.

When the apparatus is operated by the external power source at the normal temperature, the EVF display section 6 constantly performs the four-point pixel shift to allow the user to observe the high-definition image.

FIG. 10 shows the flowchart of the normal operation with the battery in detail performed in step S5 shown in FIG. 8.

Upon start of the routine, it is determined whether the operation mode of the image pickup apparatus is in the reproduction mode or the recording mode in step S41.

When it is determined that the operation is in the recording mode, the operation in the first recording mode to be described later is performed in step S42, and the process returns to step S41.

In step S41, when it is determined that the operation is in the reproduction mode, it is determined whether the image to be reproduced is the still image or the motion image in step S43.

When it is determined that the still image is to be reproduced, the system controller 14 controls the compression/extension section 3 to perform the spatial frequency analysis of the image in step S44. The compression/extension section 3 is structured to perform the spatial frequency analysis for the conversion relevant to the spatial frequency such as the DCT conversion and the wavelet transform upon compression/extension of the image. However, the aforementioned operation may be performed by the image processing circuit 2 instead of the compression/extension section 3, or by the circuit exclusive for the spatial frequency analysis. The system controller 14 may be structured to perform the spatial frequency analysis by itself.

In step S45, it is determined whether or not the image contains the high frequency component based on the result of the spatial frequency analysis performed in step S44.

When it is determined that the high frequency component is contained, the EVF display section 6 is set to be operated in the four-point pixel shift mode to allow the user to observe the high-definition image in step S46.

In step S45, when it is determined that the high frequency component is not contained, the EVF display section 6 is set to be operated in the two-point pixel shift mode to allow the user to observe the high-definition image to a certain degree while saving the power in step S47.

Meanwhile in step S43, when it is determined that the image to be reproduced is the motion image rather than the still image, the image processing circuit 2 or the system controller 14 detects the motion of the motion image in step S48. The motion detection is performed to determine whether or not the fast moving subject is contained in the motion image using the known detection technology.

In step S49, it is determined whether or not the motion image contains the fast moving subject based on the result of the motion detection in step S48. When it is determined that no fast moving subject is contained in the motion image, the process proceeds to step S47 where the motion image is displayed in the two-point pixel shift mode.

In step S49, when it is determined that the fast moving subject is contained, the EVF display section 6 is set to be operated in the LPF mode to perform the high speed image processing in step S50.

In case of the normal operation with the battery, the still image which contains the high frequency component is displayed in the four-point pixel shift mode to allow the user to observe the high-definition image to a maximum extent. In case of the still image with no high frequency component or the motion image with no fast moving subject are displayed in the two-point pixel shift mode. The motion image with the fast moving subject is displayed in the LPF mode having the display delay time relatively shorter. In the LPF mode, a plurality of sub-frame images do not have to be generated, thus reducing the time required for processing the image. This makes it possible to suppress the delay in the display of the fast moving subject.

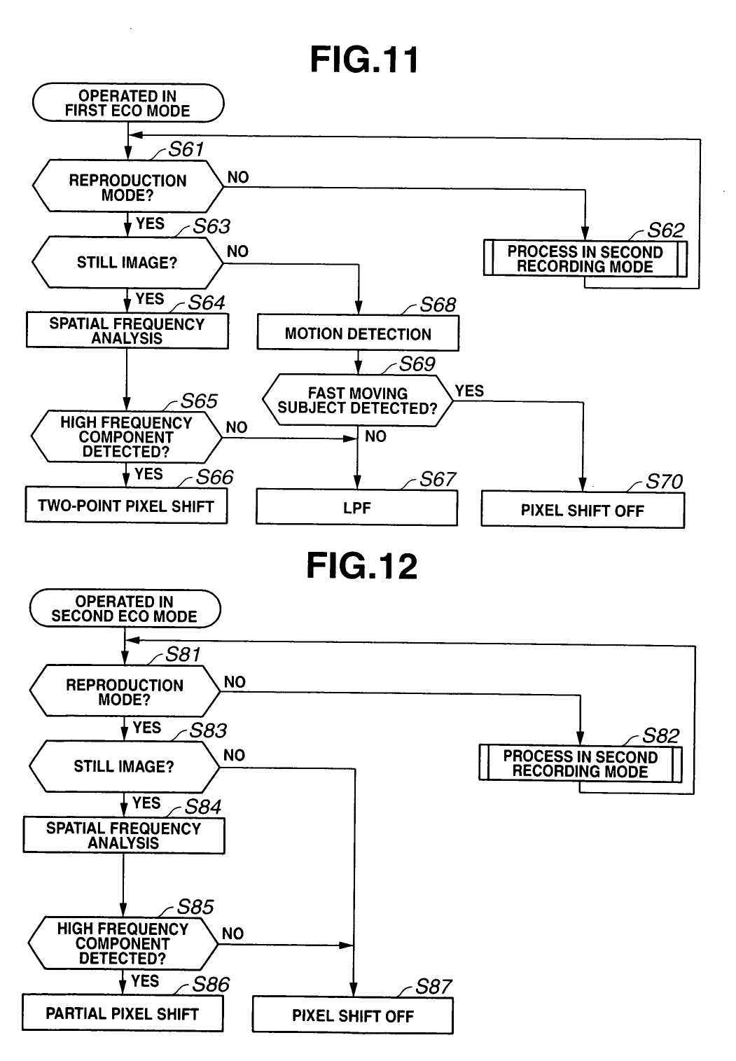

FIG. 11 shows the flowchart of the detail of the routine in the first eco mode in step S7 shown in FIG. 8.

Upon start of the routine, it is determined whether the image pickup apparatus is operated in the reproduction mode or the recording mode in step S61.

When it is determined that the operation is performed in the recording mode, the operation in the second recording mode to be described later is performed in step S62. Thereafter, the process returns to step S61.

In step S61, when it is determined that the operation is performed in the reproduction mode, it is further determined whether the image to be reproduced is the still image or the motion image in step S63.

When it is determined that the still image is to be reproduced, the spatial frequency analysis of the image is performed as described above in step S64.

In step S65, it is determined whether the image contains the high frequency component based on the result of the spatial frequency analysis performed in step S64.

When it is determined that the high frequency component is contained, the operation mode for the EVF display section 6 is set to be operated in the two-point pixel shift mode to allow the user to observe the high-definition image to a certain degree while saving the power in step S66.

In step S65, when it is determined that the high frequency component is not contained, the EVF display section 6 is set to be operated in the LPF mode to allow the user to observe the high quality image to the certain degree while saving the power in step S67.

Meanwhile in step S63, when it is determined that the image to be reproduced is the motion image rather than the still image, the motion of the motion image is detected as described above in step S68.

Based on the result of the motion detection in step S68, it is determined whether or not the fast moving subject is contained in the motion image in step S69. When it is determined that the fast moving subject is not contained, the process proceeds to step S67 where the motion image is displayed in the LPF mode.

In step S69, when it is determined that the fast moving subject exists, the EVF display section 6 is set to be operated in the pixel shift OFF mode to allow the high speed image processing while saving the power in step S70.

In the first eco mode, the still image which contains the high frequency component is displayed in the two-point pixel shift mode so as to allow the user to observe the high-definition image to a certain degree while saving the power. The still image with no high frequency component or the motion image with no fast moving subject will be displayed in the LPF mode. The motion image with the fast moving subject is displayed in the pixel shift OFF mode with the short display delay time.

FIG. 12 is the flowchart showing the detail of the operation in the second eco mode in step S9 shown in FIG. 8.

Upon start of the routine, it is determined whether the operation mode of the image pickup apparatus is in the reproduction mode or the recording mode in step S81.

When it is determined that the recording mode is set, the process in the second recording mode to be described later is performed in step S82, and the process returns to step S81.

In step S81, when it is determined that the reproduction mode is set, it is further determined whether the image to be reproduced is the still image or the motion image in step S83.

When it is determined that the still image is to be reproduced, the spatial frequency analysis of the image is performed in step S84.

It is determined whether or not the image contains the high frequency component in step S85 based on the result of the spatial frequency analysis performed in step S84.

When it is determined that the high frequency component is contained, the EVF display section 6 is set to be operated in the partial pixel shift mode so as to allow the user to observe the high-definition image of the required portion while saving the power in step S86.

In step S83, when it is determined that the image to be reproduced is the motion image rather than the still image, or it is determined that the high frequency component is not contained in step S85, the EVF display section 6 is set to be operated in the pixel shift OFF mode to further save the power in step S87.

In the second eco mode, the still image with the high frequency component is displayed in the partial pixel shift mode to allow the user to observe the high-definition image of the certain portion while saving the power. The still image with no high frequency component or the motion image will be displayed in the pixel shift OFF mode.

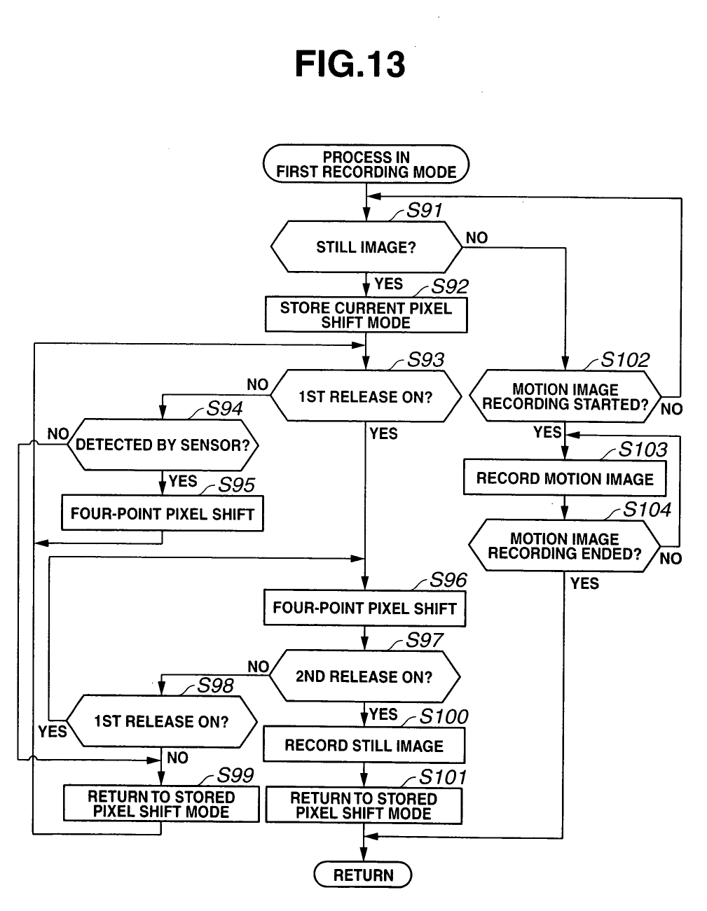

FIG. 13 is the flowchart showing the detailed operation in the first recording mode executed in step S42 shown in FIG. 10.

Upon start of the routine, it is determined whether the image to be recorded is the still image or the motion image in step S91.

When it is determined that the still image is to be recorded, the current pixel shift mode is stored in step S92.

In response to the depression of the release button 13a halfway, it is determined whether or not the 1st release switch has been ON in step S93.

When it is determined that the 1st release switch has been OFF, the pixel shift display determination section 14a further determines whether the user observes the image via the EVF display section 6 by the eye detection unit 36, whether the focus ring 13b is operated, and the user is in the middle of the focus adjustment process, and whether the grip portion 53 is grasped in step S94.

When it is determined that the observation is performed through the EVF display section 6, the focus is adjusted, or the grip portion 53 is grasped, it is preferable to display the high-definition image on the EVF display section 6. So the EVF display section 6 is set to be operated in the four-point pixel shift mode in step S95. The process returns to step S93 and is kept stand-by until the 1st release switch is turned ON.

When it is determined that the 1st release switch is ON in step S93, it is preferable to display the high-definition image to confirm whether or not the focus adjustment is performed at the target position set by the user such that the image pickup apparatus is AF and AE operated in step S96. So the EVF display section 6 is set to be operated in the four-point pixel shift mode in step S96.

It is determined whether or not the 2nd release switch has been ON in response to the full pressing of the release button 13a in step S97.

When it is determined that the 2nd release switch has been OFF, it is further determined whether or not the 1st release switch has been kept ON in step S98.

When it is determined that the 1st release switch has been kept ON, the process returns to step S96 where the display in the four-point pixel shift mode is continued.

Meanwhile, in step S98, when it is determined that the 1st release switch has been turned to OFF, or when the observation of the user with respect to the EVF display section 6, the focus adjustment, and the grasping of the grip portion are not detected in step S94, the process proceeds to step S99 where the display mode of the EVF display section 6 is returned to the pixel shift mode stored in step S92. The process further proceeds to step S93 to detect the operation of the 1st release switch.

In step S97, when it is detected that the 2nd release switch has been set to ON, the process proceeds to step S100 where the still image is picked up by the image pickup apparatus 1, and the image is processed by the image processing circuit 2 and the compression/extension section 3 so as to be recorded in the detachable memory 8.

In step S101, the display mode is returned to the pixel shift mode stored in step S92, and the process returns.

In step S91, when it is determined that the image intended to be recorded is the motion image, the process proceeds to step S102 where it is determined whether or not the record of the motion image has been started via the operation section 13.

When it is determined that the record of the motion image has not been started, the process returns to step S91 for executing the aforementioned process.

In step S102, when it is determined that the record of the motion image has been started, the process proceeds to step S103 where the motion image is picked up by the image pickup section 1, and the image is processed by the image processing circuit 2 and the compression/extension section 3 so as to be recorded in the detachable memory 8.

It is determined whether or not the operation for ending the record of the motion image has been performed via the operation section 13 in step S104. When it is determined that the operation has not been performed, the process proceeds to step S103 where the motion image is continuously recorded. When it is determined that the operation has been already performed, the process returns from the first recording mode process.

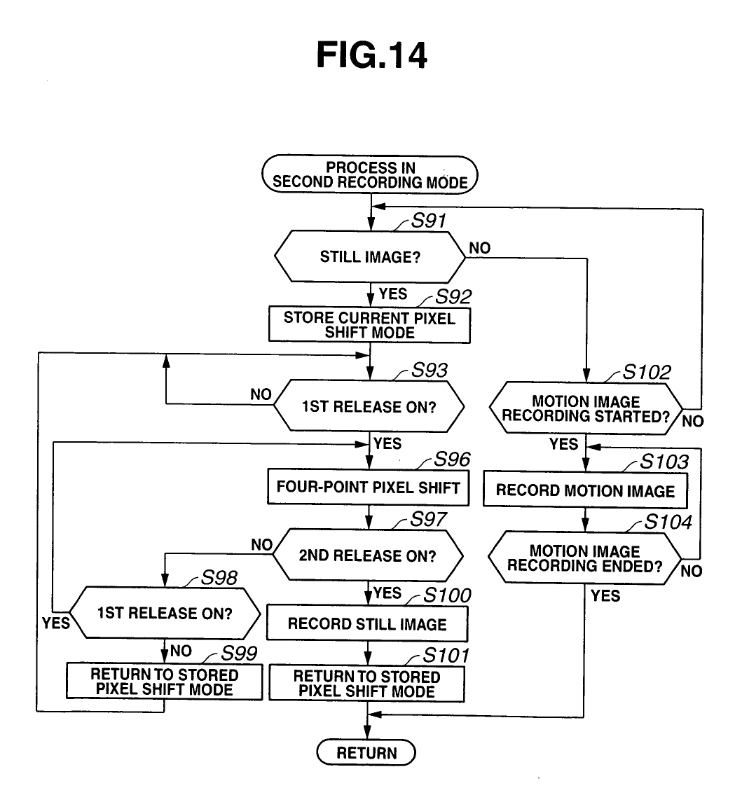

FIG. 14 is a flowchart showing the process in the second recording mode performed in step S62 shown in FIG. 11 and in step S82 shown in FIG. 12 in detail.

The process in the second recording mode is substantially the same as that in the first recording mode shown in FIG. 13, and the same steps will be designated with the same reference numerals, and the explanations thereof will be omitted.

The process in the second recording mode eliminates the process in steps S94 and S95 from the first recording mode.

In step S93, when it is determined that the 1st release switch has been in OFF state, in the second recording mode, the process in step S93 will be repeatedly executed to be kept standby until the 1st release switch is turned ON.

Other features are the same as those of the process in the first recording mode shown in FIG. 13.

The process in the second recording mode allows the display in the four-point pixel shift mode only when the 1st release switch is turned ON rather than the detection of the user. This makes it possible to further save the power.

FIG. 15 is a flowchart showing the interruption process set by the user.

The process is executed as the interruption when the user sets the display mode of the EVF display section 6 via the operation section 13 while observing the menu display.

Upon start of the process, it is determined whether or not the temperature (operational temperature) is the value to sufficiently allow the operation for the display in the pixel shift mode set by the user based on the output from the sensor 7 in step S111.

When it is determined that the temperature is the operational value, the pixel shift display determination section 14a determines whether the battery feeds power to the power source 11 (the image pickup apparatus is driven by the battery) or the external power source feeds power to the power source 11 (the image pickup apparatus is driven by the external power source) in step S112.

When it is determined that the power is fed from the external power source, the pixel shift mode inputted by the user is set in step S113.

When it is determined that the power is fed from the battery, it is determined whether or not the remaining level of the battery is sufficient for operating the pixel shift mode set by the user in step S114.

When it is determined that the remaining level of the battery is sufficient, the process proceeds to step S113 where the pixel shift mode inputted by the user is set.

Meanwhile, in step S114, when it is determined that the remaining level of the battery is insufficient, or when it is determined that the temperature is not in the operational state in step S11, the alarm is displayed for a predetermined period, and the process returns to the previous process without changing the display mode of the EVF 6.

When the predetermined time elapses without operating the image pickup apparatus, the pixel shift mode set by the user interruption will be shifted to the pixel shift OFF mode in step S10 shown in FIG. 8.

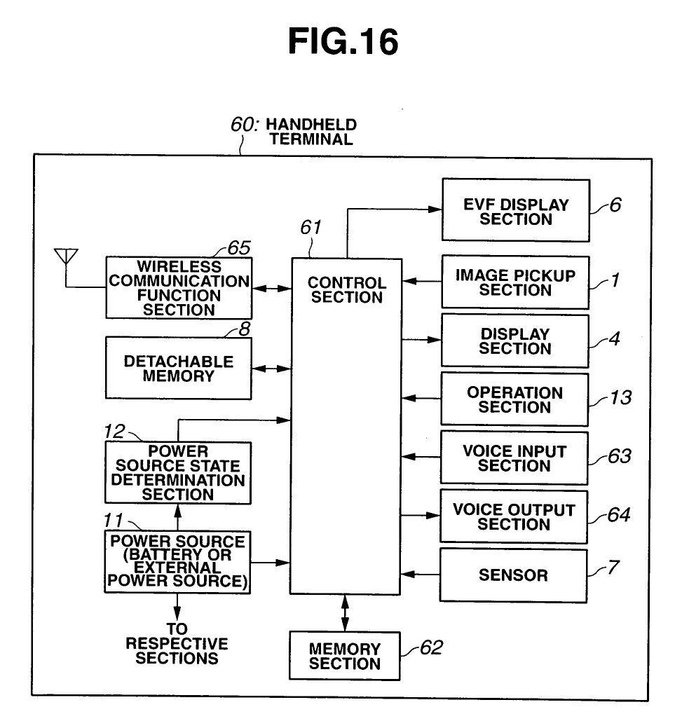

FIG. 16 is a block diagram showing an example of a handheld terminal to which the image pickup apparatus is applied.

A handheld terminal 60 is formed by applying the image pickup apparatus shown in FIG. 1 to a PDA (Personal Digital Assistant) and a cell phone. In FIG. 16, the same components of the handheld terminal as those shown in FIG. 1 will be designated with the same reference numerals, and the explanations thereof, thus will be omitted.

The handheld terminal 60 includes the image pickup section 1, the display section 4, the EVF display section 6, the sensor 7, the detachable memory 8, the power source 11, the power source state determination section 12, the operation section 13, a control section 61, a memory section 62, a voice input section 63, a voice output section 64, and a wireless communication function section 65.

The handheld terminal 60 is provided with a camera having the wireless function and the EVF display section with the pixel shift function.

The image pickup section 1 is formed as a CCD camera with a CCD image pickup device, which picks up a still image and a motion image, and converts such image into the digital signal so as to be outputted likewise the image pickup section 1 shown in FIG. 1.

The display section 4 is provided with the LCD or the like for displaying the image or the various information data with respect to the handheld terminal 60 likewise the display section 4 shown in FIG. 1.

The EVF display section 6 has substantially the same structure as the one shown in FIG. 1, which is provided with the pixel shift element 44 so as to be allowed to display the image in the pixel shift mode.

The sensor 7 includes the temperature sensor likewise the sensor 7 shown in FIG. 1. A sensor may be provided in the grasping portion of the handheld terminal 60 to detect the state of the use.

The detachable memory 8 is a recording medium having the still image and the motion image recorded therein likewise the detachable memory 8 shown in FIG. 1.

The power source 11 supplies power fed form the battery or the external power source to the respective components inside the handheld terminal 60 in the stable state likewise the power source 11 shown in FIG. 1. The handheld terminal 60 is driven by the battery in the normally portable state, and may be driven by the external power source through connection with the AC adapter.

The power source state determination section 12 determines whether the power source 11 receives power from the battery or the external power source, and further determines with respect to the remaining level of the battery by detecting its voltage when it is determined that the battery feeds the power likewise the power source state determination section 12 shown in FIG. 1. The determination result of the power source state determination section 12 is transferred to the control section 61.

The operation unit 13 includes the power switch which turns the power of the handheld terminal 60 ON/OFF (OFF brings the standby mode, and ON brings the recording/reproduction mode), the mode selector switch for setting the operation mode of the handheld terminal 60 to the recording/reproduction mode, the motion image/still image selector switch for setting either the motion image or the still image to be recorded in the recording mode, the release button for commanding and inputting the image pickup operation, the button for setting the pixel shift mode of the EVF display section 6, the button or the like for various selection and moving operations, the numeric keypad, and the other function keys.

The control section 61 controls operations of various components based on the control program stored in the memory section 62 likewise the system controller 14 shown in FIG. 1. The memory section 62 of the handheld terminal 60 has the function of the nonvolatile memory 10 shown in FIG. 1.

The memory section 62 stores the control program, various parameters as described above and further the image data.

The voice input section 63 includes a microphone for allowing the user to input the voice.

The voice output section 64 includes a speaker and a transmitter through which the voice output is performed.

The wireless communication function section 65 is used for the wireless communication with the external equipment.

The detailed structure of the handheld terminal 60 is not shown in FIG. 16. However, the structure as shown in FIG. 1 may be provided to the handheld terminal 60 herein.

In the case where the thus structured handheld terminal 60 is required to display the still image and to display the high-resolution image with a large number of characters, the display content is determined by the control section 61, or based on the input by the user via the operation section 13 to perform the pixel shift display in the appropriate display mode on the EVF display section 6. In the case where the low resolution image requiring no pixel shift, or the motion image is displayed, the pixel shift display mode is turned to OFF state to save the power. The detail of the operation of the handheld terminal 60 is substantially the same as the operation of the aforementioned image pickup apparatus. However, it is different from the aforementioned image pickup apparatus in that the volume of the character information to be displayed on the screen is determined to control the display mode based on the result of the determination.

The control section 61 is structured to control the operation with the low power consumption by setting the display section 4 to the non-display mode while the EVF display section 6 is operated.

The other operation in the handheld terminal 60 is the same as that of the generally employed handheld terminal, and the explanation thereof, thus will be omitted.

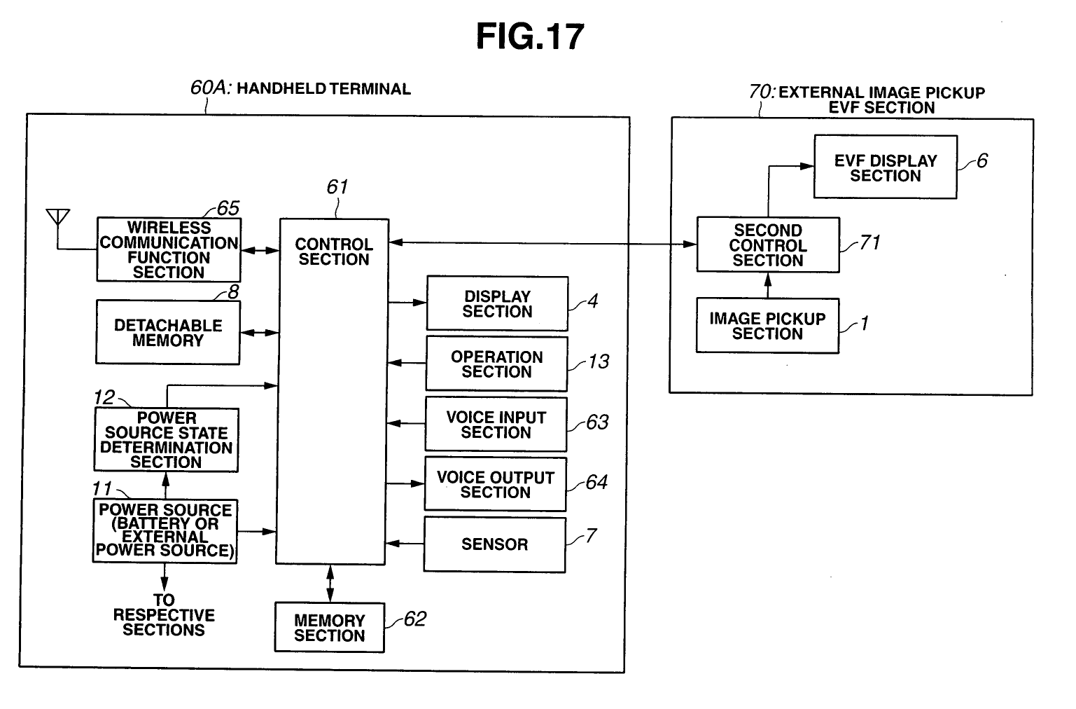

FIG. 17 is a block diagram showing the exemplary structure of the handheld terminal having the image pickup section and the EVF display section externally provided. Referring to FIG. 17, the same components as those shown in FIG. 16 will be designated with the same reference numerals, and explanations thereof, thus will be omitted.

A handheld terminal 60A has configuration in which the image pickup section 1 and the EVF display section 6 are omitted from the components of the handheld terminal shown in FIG. 16. The handheld terminal 60A allows an external image pickup EVF section 70 to be detachably connectable.

The external image pickup EVF section 70 includes the image pickup section 1, the EVF display section 6, and a second control section 71. The image pickup section 1 and the EVF display section 6 are connected to the second control section 71. When the external image pickup EVF section 70 is attached to the handheld terminal 60A, the second control section 71 is connected to the control section 61 of the handheld terminal 60A so as to be bi-directionally communicated with each other. The second control section 71 processes the image data from the image pickup section 1 under the control of the control section 61, and performs the display control of the EVF display section 6.

The display section 4 contained in the handheld terminal 60A generally is limited to the size so as not to deteriorate the portability. Assuming that the handheld terminal 60A is applied to the cell phone to be used as the TV phone, the display section 4 is not large enough to satisfy the intended use. The handheld terminal 60A is structured to have the EVF display section 6 and the image pickup section 1 externally attached.

The external image pickup EVF section 70 is not limited to the type which is directly attached to the handheld terminal 60A (or through wired connection). It may be operated through the wireless communication. In this case, the external image pickup EVF section 70 is provided with the wireless communication function section or the power source and the like.

Referring to FIG. 17, the handheld terminal 60A contains the control section 61, and the external image pickup EVF section 70 contains the second control section 71. Alternatively, the control section 61 may be structured to also function as the second control section 71. In this case, the external image pickup EVF section 70 is provided with the image pickup section 1 and the EVF display section 6.

The operations of the handheld terminal 60A and the external image pickup EVF section 70 shown in FIG. 17 are substantially the same as those described referring to FIG. 16.

In the embodiment shown in FIGS. 16 and 17, the PDA and the cell phone are described as the handheld terminals 60 and 60A. Not being limited thereto, the present invention may be applied to the device in the wider range so long as it is provided with the EVF display section with the pixel shift function.

In the embodiment, the frame sequential type display mode including the color framed sequential type illumination section and the monochrome type liquid crystal, and the display mode using the display element with RGB color filter have been described. However, the display mode is not limited to the aforementioned modes. The mode using the reflection type LCD (LCOS) rather than the transmission type, and the mode using the DMD for obtaining the image information modulated through oscillation of the tiny mirror may also be employed. The display element such as the EL element or the display element of self-emission type such as the LED array may also be employed. The specific examples of the display mode will be described hereinafter.

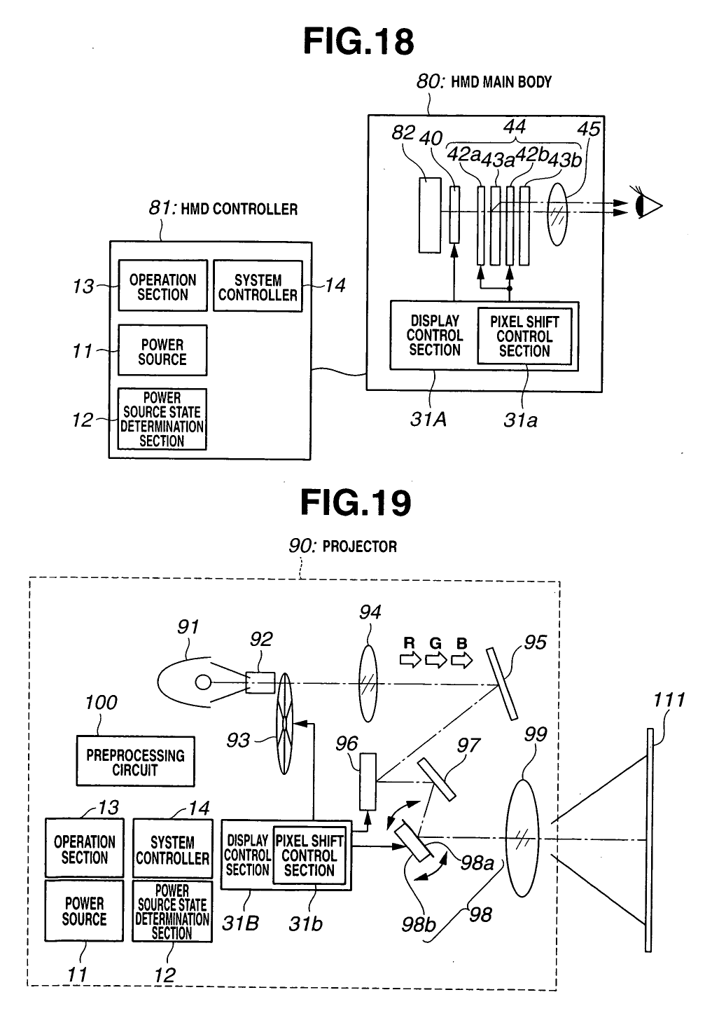

FIG. 18 is a block diagram showing the exemplary structure of a head mount display (HMD) as the image display unit.

The HMD is configured as an HMD by extracting components from the image display unit in the image pickup apparatus shown in FIG. 1. The components shown in FIG. 18 substantially the same as those shown in FIG. 1 will be designated with the same reference numerals, and explanations thereof, thus will be omitted.

The HMD includes an HMD main body 80, and an HMD controller 81, which are connected so as to be communicated wired or wirelessly.

The HMD main body 80 is used being attached to the head portion, and is separated from the HMD controller 81 so as to be made light and compact wherever possible. The HMD controller 81 is provided with main functions as the image display unit except the essential function of the HMD main body 80. The HMD main body 80 includes a backlight 82 as the illumination section, the display element 40, the pixel shift element 44, the eye optical system 45, and a display control section 31A as display control means. Unlike the structure shown in FIG. 1, the HMD main body 80 includes the backlight 82 as the illumination section with the light source. The display control section 31A has basically the same structure as that of the EVF display control section 31 shown in FIG. 1, which is provided with the pixel shift control section 31a. The backlight 82 is structured to have the white LED light source, and to have the display element 40 as the single LCD or the like for making the HMD main body 80 light and compact.

The HMD controller 81 includes the power source 11, the power source state determination section 12, the operation section 13, and the system controller 14.

In FIG. 18, the detailed features of the HMD are omitted. However, the structure shown in FIG. 1 may be added.

Likewise the operation as described above, with the HMD shown in FIG. 18, it is determined whether the power source 11 is driven by the battery or the external power source, and further determined with respect to the remaining level of the battery by detecting the battery voltage when it is determined that the power source 11 is driven by the battery. Based on the determination result, the display mode is selected from the four-point pixel shift mode, the two-point pixel shift mode, the partial pixel shift mode, the LPF mode, and the pixel shift OFF mode.

The image display unit such as HMD attached to the head is allowed to display the high-definition and high quality image by setting the appropriate display mode in accordance with the power source state while elongating the service period.

FIG. 19 is a block diagram showing the exemplary structure of the projector as the image display unit.

An image projector 90 is configured as a projector by extracting the components from the image display unit of the image pickup apparatus shown in FIG. 1. So the components shown in FIG. 19 which are substantially the same as those shown in FIG. 1 will be designated with the same reference numerals, and explanation thereof, thus will be omitted.

The projector 90 is designed to be portable using the battery as the power source.

The projector 90 includes the power source 11, the power source state determination section 12, the operation section 13, the system controller 14, a display control section 31B as display control means, a white light source 91, an integrator rod 92, an illumination color selector 93, an illumination optical system 94, a mirror 95, a display element 96, a mirror 97, a pixel shift element 98, a projection optical system 99 as an extension optical system, and a preprocessing circuit 100.

The white light source 91 includes an extra high pressure mercury lamp for emitting the white light.

The integrator rod 92 forms a plurality of luminescent spots of the light source through the internal reflection to generate a uniform illumination light by eliminating unevenness thereof.

The illumination selector 93 serves to time-series extract the color component of the light irradiated from the white light source 91, which is formed as the color wheel, for example. The color wheel includes three color filters, that is, an R filter which transmits only R (red) wavelength, a G filter which transmits only G (green) wavelength, and a B filter which transmits only B (blue) wavelength circumferentially arranged on a disk which is rotated by drive means such as a motor. The color wheel is allowed to time division generate three colors of RGB sequentially.

The illumination optical system 94 is an optical system for efficiently irradiating the illumination light from the illumination selector 93 to the display element 96.

The mirror 95 serves to reflect the illumination light from the illumination optical system 94 toward the display element 96.

The display element 96 is structured to have, for example, the DMD (digital micromirror device).

The mirror 97 reflects the modulated light from the display element 96 toward the pixel shift element 98.

The pixel shift element 98 includes a mirror 98a, and a drive unit 98b for imperceptibly oscillating the mirror 98a to perform the pixel shift operation through the imperceptible oscillation of the mirror 98a. The drive unit 98b is structured as oscillation means provided with the voice coil or the like. The pixel shift element 98 shown in FIG. 19 is structured to perform so called mechanical pixel shift operation.

The projection optical system 99 serves to project the image modulated by the display element 96 and extended through the pixel shift element 98 to a screen 111 as a real image.

The display control section 31B has basically the same structure as that of the EVF display control section 31 shown in FIG. 1, and includes the pixel shift control section 31b. In the example shown in FIG. 19, the subjects to be controlled are the illumination color selector 93, the display element 96, the pixel shift element 98 and the like, which are different from the case shown in FIG. 1, and designated with different reference numerals.

The preprocessing circuit 100 processes various image signals so as to be converted into a format to be displayed on the display element 96. For example, the preprocessing circuit 100 performs the resolution conversion, the frame rate conversion, and the IP (Interlaced Progressive) conversion. The display control section 31B executes the pixel shift control such that the image signal processed by the preprocessing circuit 100 to be displayed with high resolution.

In the example shown in FIG. 19, the mechanical pixel shift structure is employed, which is substantially the same as the pixel shift performed to shift the pixel position by half the pixel on the screen 111. Accordingly, the resultant resolution is the same as the one described above.

Likewise the operation as described above, with the projector 90 shown in FIG. 19, it is determined whether the power source 11 is driven by the battery or the external power source, and further determined with respect to the remaining level of the battery by detecting the battery voltage when it is determined that the power source 11 is driven by the battery. Based on the determination result, the display mode is selected from the four-point pixel shift mode, the two-point pixel shift mode, the partial pixel shift mode, the LPF mode, and the pixel shift OFF mode.

The projector 90 as the image display unit which projects the extended image as the real image is allowed to display the high-definition and high quality image by setting the appropriate display mode in accordance with the power source state while elongating the service period.

The pixel shift element is not limited to the structure as the combination of the polarized switching liquid crystal and the birefringent plate. The technology for performing the pixel shift using the mechanical oscillation may be employed as described above. Alternatively the pixel shift element using the technology in which only the liquid crystal may be used for changing the refracting angle and the displacing direction of the incident polarized light by the birefringence of the inclined liquid crystal molecule as disclosed in Japanese Unexamined Patent Application Publication Nos. 9-133904 and 2002-328402 may be employed. The technology which controls the switching of the pixel shift by turning the electrically applied voltage ON/OFF may not cause the oscillation unlike the technology using the actuator or the like to cause the mechanical oscillation to perform the pixel shift operation, thus suppressing the increase in the power consumption and generating no ablation owing to the oscillation. Additionally, the pixel shift by turning the electrically applied voltage ON/OFF is capable of realizing the pixel shift operation by stably shifting the light ray so as to display the image with high accuracy at lower costs.

The structure shown in FIG. 1 includes the system controller 14 and the EVF display control section 31 separately. However, the EVF display control section 31 may be eliminated by allowing the system controller 14 to serve to perform the function of the EVF display control section 31.

In the aforementioned description, the pixel shift operation is performed in the order of the pixel position of A, C, B and D. However, it is not limited to the aforementioned order.

In the aforementioned description, the display mode is selected from the plurality of pixel shift modes depending on the power source state, the apparatus temperature, the still/motion image, the reproduction/recording mode, and the like. However, it is not limited to the aforementioned. The image processing of a plurality of sub-frame images requires relatively high power. However, the power for driving the pixel shift element 44 in the multi-point pixel shift mode requires less power. As the display in the LPF mode saves sufficient power, the LPF mode may be selected instead of the pixel shift display OFF mode. The pixel shift mode set in the aforementioned flowchart may be replaced by the other pixel shift mode.

In the aforementioned description, the sub-frame memory 32 is provided separately from the built-in memory 9. However, those memories may be integrated. In this case, the total capacity of the memory is reduced to be able to decrease the cost.

When the fast moving subject is contained in the motion image, it is reproduced in the LPF mode or the pixel shift OFF mode. When the fast moving subject exists, the through image upon the pickup of the still image may be displayed in the LPF mode or the pixel shift OFF mode. The image processing of the plurality of sub-frame images may take a long processing time, which may delay the display. Especially when the fast moving subject exists, such delay causes the user to miss the shutter chance. The LPF mode or the pixel shift OFF mode may suppress the probability of missing the shutter chance. However, the aforementioned mode setting is not necessarily restrictive so long as the high speed image processing circuit may be used to ensure sufficient image transfer speed.

In the aforementioned structure, the pixel shift mode is changed in accordance with the detection of the user's eye by the eye detection unit 36. It may be structured to interrupt the power supply to the entire EVF display section 6 in the case where the user's eye is not detected by the eye detection unit after an elapse of a predetermined time.

In the structure shown in FIG. 1, the EVF display section 6 contains the EVF display control section 31, the sub-frame memory 32, the light source drive circuit 33, the display element drive circuit 34, and the SW liquid crystal drive circuit 35. However, the sub-frame memory 32 and the built-in memory 9 may be composed as one memory as described above.

As the multi-point pixel shift modes, the four-point pixel shift mode and the two-point pixel shift mode are described. However, the three, five, or more multi-point pixel shift mode may be employed.

In the aforementioned description, the spatial frequency analysis is performed with respect only to the still image. The spatial frequency analysis may be performed with respect to the motion image, based on which the pixel shift mode may be changed.

In the aforementioned description, the pixel shift mode may be changed not only based on the remaining level of the battery but also based on the combinations of such factors as the device temperature, high frequency component of the spatial frequency and the motion of the motion image in consideration of the actual product. The power consumption in the respective display modes may become smaller in the order of the four-point pixel shift mode, the two-point pixel shift mode, the partial pixel shift mode, the LPF mode, and the pixel shift OFF mode. Assuming that only the remaining level of the battery is considered, the display mode may be changed in the aforementioned order as the remaining level of the battery becomes low.

In the aforementioned embodiment, the image is displayed in the appropriate mode selected from a plurality of modes each having the different pixel shift operation and different power consumption in accordance with the power source state and the device temperature. This makes it possible to display the image with high definition in the pixel shift mode while elongating the operation time of the apparatus as long as possible.

The pixel shift mode for the display is controlled based on the operation in the recording/reproduction mode. This makes it possible to appropriately display the image in accordance with the operation mode.

The display mode may be changed depending on whether the high frequency component exists in the still image, and the fast moving subject is contained in the motion image. This makes it possible to set the appropriate display mode in accordance with the subject while reducing the power consumption.

The pixel shift display mode may be switched in accordance with whether or not the user operates the apparatus. This makes it possible to display the high definition image when needed while reducing the power consumption.

The handheld terminal is structured to display the high-definition image when needed in accordance with the size of the character information, and not to display the high-definition image if it is not needed. This makes it possible to reduce the power consumption appropriately depending on the information to be displayed.

The display mode with the required resolution may be selected in accordance with the apparatus state to allow the high definition display as much as possible while saving power. This makes it possible to extend the time for driving the battery driven apparatus while keeping the required performance.

Having described the preferred embodiments of the invention referring to the accompanying drawings, it should be understood that the present invention is not limited to those precise embodiments and various changes and modification thereof could be made by one skilled in the art without departing from the spirit or scope of the invention as defined in the appended claims.

1. An image display apparatus comprising:
a pixel shift extension display section which includes a display element, a pixel shift element which enables a high definition display with a number of pixels greater than a number of pixels of the display element by cyclically varying a spatial position of an image to be displayed on the display element, and an extension optical system which extends the image displayed on the display element through the pixel shift element;
a display controller which controls the pixel shift extension display section in one of a plurality of display modes, each having a different pixel shift operation and a different power consumption;
a power source structured to receive power at least from a battery;
a power source state determination section which determines a remaining level of the battery; and
a mode setting unit which sets the display mode controlled by the display controller in such a way that the display mode, in a case in which a determination result of the power source state determination section shows that a remaining level of the battery is relatively low, is a display mode with power consumption lower than that of the display mode in a case in which the determination result shows that the remaining level of the battery is relatively high.

2. The image display apparatus according to claim 1, wherein the plurality of display modes include a multi-point pixel shift mode which performs the high definition display with the number of pixels a plurality of times greater than the number of pixels of the display element by forming an image to be displayed on the display element into a different image corresponding to a different spatial position when the pixel shift element cyclically varies the spatial position of the image, and a pixel shift OFF mode where the pixel shift element is not driven.

3. The image display apparatus according to claim 2, wherein the plurality of display modes further include a lowpass filter (LPF) mode for forming the image to be displayed on the display element as a same image in one cycle in which the pixel shift element cyclically varies the spatial position of the image.

4. The image display apparatus according to claim 2, wherein the plurality of display modes further include a partial pixel shift mode which performs the high definition display with the number of pixels a plurality of times greater than the number of pixels of the display element with respect to a portion of the image by forming the portion of the image to be displayed on the display element to a different image corresponding to a different spatial position when the pixel shift element cyclically varies the spatial position of the image.

5. The image display apparatus according to claim 2 further comprising an operation unit for performing operations of the image display apparatus, wherein the mode setting unit sets the display mode to the pixel shift OFF mode when a predetermined time elapses in a state where the operation unit is not operated.

6. The image display apparatus according to claim 1, wherein:
the power source is structured to receive power from an external power source;
the power source state determination section is further configured to determine whether the power source receives the power from one of the battery and the external power source;
the mode setting unit sets the display mode controlled by the display controller in such a way that the display mode in a case in which a determination result of the power source state determination section shows that the power source receives the power from the battery is a display mode with power consumption lower than that of the display mode in a case in which the determination result shows that the power source receives the power from the external power source.

7. The image display apparatus according to claim 1 further comprising a measurement unit which measures an environmental condition of the image display apparatus, wherein the mode setting unit sets the display mode controlled by the display controller based on a measurement result of the measurement unit in a given range corresponding to the determination result of the power source state determination section.

8. The image display apparatus according to claim 7, wherein:
the measurement unit includes a temperature sensor which measures a temperature as the environmental condition of the image display apparatus; and
the mode setting unit sets the display mode controlled by the display controller in such a way that the display mode in a case in which the temperature measured by the temperature sensor is relatively high is a display mode with power consumption lower than that of the display mode in a case in which the measured temperature is relatively low in the given range corresponding to the determination result of the power source state determination section.

9. The image display apparatus according to claim 1 further comprising a spatial frequency analyzer which analyzes a spatial frequency of the image, wherein, when an analytical result of the spatial frequency analyzer shows that a high frequency component is contained in the image to be displayed on the pixel shift extension display section, the mode setting unit sets the display mode controlled by the display controller with a definition higher than a definition when the analytical result shows that the high frequency component is not contained in the image in a given range corresponding to the determination result of the power source state determination section.

10. The image display apparatus according to claim 1 further comprising a motion detection unit which detects a motion of a subject contained in a motion image, wherein the mode setting unit sets the display mode controlled by the display controller in such a way that the display mode in the case in which the image to be displayed on the pixel shift extension display section is the motion image, and a detection result of the motion detection unit shows that a fast moving subject is contained in the image is a display mode with a display delay time shorter than that of the display mode in case in which the detection result shows that the fast moving subject is not contained in the image in a given range corresponding to the determination result of the power source state determination section.

11. The image display apparatus according to claim 1, wherein the extension optical system is an eye optical system, the image display apparatus further comprising an eye detection unit which detects whether or not an observation is performed using the pixels shift extension display section, wherein, when the eye detection unit detects that the observation is performed using the pixel shift extension display section, the mode setting unit sets the display mode controlled by the display controller to the display mode with a high definition in a possible range corresponding to the determination result of the power source state determination section.

12. An image pickup apparatus comprising:
an image display apparatus which includes:
a pixel shift extension display section provided with a display element, a pixel shift element which enables a high definition display with a number of pixels greater than a number of pixels of the display element by cyclically varying a spatial position of an image to be displayed on the display element, and an extension optical system which extends the image displayed on the display element through the pixel shift element;
a display controller which controls the pixel shift extension display section in one of a plurality of display modes each having a different pixel shift operation and a different power consumption;
a power source structured to receive power at least from a battery;
a power source state determination section which determines a remaining level of the battery; and
a mode setting unit which sets the display mode controlled by the display controller in such a way that the display mode, in a case in which a determination result of the power source state determination section shows that the remaining level of the battery is relatively low, is a display mode with power consumption lower than that of the display mode in a case in which the determination result shows that the remaining level of the battery is relatively high; and
an image pickup for picking up an image, wherein the image display apparatus is configured to be enabled to display the image picked up by the image pickup.

13. The image pickup apparatus according to claim 12 capable of setting a recording mode which allows the image pickup to perform an image pickup operation and a reproduction mode which allows the image display apparatus to reproduce the image and avoiding a need for the image pickup to perform the image pickup operation, the recording mode including a still image recording mode which allows the image pickup to pick up a still image, the image pickup apparatus further comprising a two-stage release button for an input operation to enable the image pickup to perform the image pickup operation when the still image recording mode is set, wherein, when a first stage of the release button is reached, the mode setting unit sets the display mode controlled by the display controller to the display mode with a high definition in a given range corresponding to a determination result of the power source state determination section.

14. The image pickup apparatus according to claim 12, wherein the image pickup includes an image pickup optical section for forming an optical image of a subject, and an image pickup device for outputting the optical image of the subject formed by the image pickup optical section as an image signal, the image pickup apparatus further comprising a manual focus adjusting unit for focus adjustment of the image pickup optical section, wherein when the focus adjustment is manually performed with the manual focus adjusting unit, the mode setting unit sets the display mode controlled by the display controller to the display mode with a high definition in the possible range corresponding to the determination result of the power source state determination section.

15. The image pickup apparatus according to claim 12 further comprising a sensing unit which senses whether or not the image pickup apparatus is in use, wherein the mode setting unit sets the display mode controlled by the display controller in such a way that the display mode in a case in which a sensing result of the sensing unit shows that the image pickup apparatus is not in use is a display mode with power consumption lower than that of the display mode in the case in which the sensing result shows that the image pickup apparatus is in use in a given range corresponding to the determination result of the power source state determination section.

16. An image display apparatus having a processing program stored in a computer readable medium, the processing program controlling the image display apparatus which includes:
a pixel shift extension display section which includes a display element, a pixel shift element which enables a high definition display with a number of pixels greater than a number of pixels of the display element by cyclically varying a spatial position of an image to be displayed on the display element, and an extension optical system which extends an image displayed on the display element through the pixel shift element;
a display controller which controls the pixel shift extension display section in one of a plurality of display modes each having a different pixel shift operation and a different power consumption under control of the processing program;
a power source structured to receive power at least from a battery; and
a power source state determination section which determines a remaining level of the battery, the processing program performing the steps of:
enabling the power source state determination section to determine the remaining level of the battery;
setting a display mode in such a way that the display mode in a case in which the determined remaining level of the battery is relatively low is a display mode with power consumption lower than that of the display mode in a case in which the remaining level of the battery is relatively high; and
enabling the display controller to control the pixel shift extension display section in the set display mode.

17. A method of controlling an image display apparatus which includes:
a pixel shift extension display section which includes a display element, a pixel shift element which enables a high definition display with a number of pixels greater than a number of pixels of the display element by cyclically varying a spatial position of an image to be displayed on the display element, and an extension optical system which extends an image displayed on the display element through the pixel shift element;
display controller which controls the pixel shift extension display section in one of a plurality of display modes each having a different pixel shift operation and a different power consumption;
a power source structured to receive power at least from a battery; and
a power source state determination section which determines with respect to a remaining level of the battery, the method comprising:
enabling the power source state determination section to determine the remaining level of the battery;
a display mode in such a way that the display mode in a case in which the determined remaining level of the battery is relatively low is a display mode with power consumption lower than that of the display mode in a case in which the remaining level of the battery is relatively high; and
enabling the display controller to control the pixel shift extension display section in the set display mode.
